(19) United States
(12) Patent Application Publication
(10) Pub. No.: US 2002/0111842 A1
(43) Pub. Date: Aug. 15, 2002

(54) Work order management system

(76) Inventor: Jon Miles, Winchester, VA (US)

Correspondence Address: Jame W. Hiney, Esq., THE TECHNOLOGY LAW OFFICES OF VIRGINIA, P.O. Box 818, Middleburg, VA, 20118, US

(21) Appl. No.: 09/781,057

(22) Filed: Feb. 9, 2001

(51) Int. Cl. G06F 17/60

(52) U.S. Cl. 705/8

(57) ABSTRACT

An on-line work order management system for accommodating a plurality of medium and small companies called vendors and customers and which is accessible by any web browser. The system includes a central database controlled by the system operator and is accessible by logging on with a customer or vendor ID. The system allows customers to create work orders for the vendors and allows the vendors access to the work orders to schedule work based thereon and to review all previously submitted work.

This invention relates to a work order management system which is easy to employ, operate and administer. It is a web server software owned and controlled by the service provider that allows clients to have a work order management system without having to have their own internal information technology system. The application is designed to run on servers controlled by the service provider and gives the customers the power and flexibility of a full power work order management system via the Internet.

The system provides clients with a web-based tool for managing their work orders, resources and communicates status change to their clients. The vendors set up their customers to permit access to their web based work order system. Each vendor is separate from any other Vendor and no vendor can see any other vendor's work order system or information. The front of screen experience for the customers of a vendor is customized to appear to the customers as if they were accessing an internal work order management site within the vendor's organization.

The customer site is accessible from any web browser and is protected by a password and username login. The operation is extremely simple and quick. Once a work order is entered into the system any change in status generates an e-mail to the requester or other designated recipient informing them of the status of the work order, whether it be completed, closed, changed or just assigned, which information they can use for their own planning or information purposes Customers can easily check what is happening from any browser they have available.

### BACKGROUND

Henceforth there has been no on line management system for work orders for the small to medium sized company which has to interact with its customers yet cannot afford the very expensive total systems being presently marketed today. The instant invention provides the control and management capability to that company without the huge cost involved by using its own servers to provide online capability in managing customer accounts and simultaneously gives the customer a way to interact with the vendor. The vendor can additionally adjust and customize what capabilities each and every customer has in the system depending on the customer and its needs. The vendor at present is faced with ordering a very expensive IT system well outside of most vendor's budgets or doing without. There is no existing system which allows the vendor to keep track of customers work orders, modify them, check them for progress and against resource and labor allocations, and match them with payments by the customer. No system allows selected employees of the customer and the vendor to access a system selectively which is cheap and operated by an outside operator owner by putting the system on line. The instant system remedies all of these shortcomings with existing systems lack of systems.

General Description of the Invention

The present invention is an on-line work order management system which allows both the vendor and customer to interact on several levels. The system, run by the servers of the owner of the system, provides the customers with a login capability, a user profile and the ability to enter work orders and to check on their progress. The customer is provided with the ability to see what equipment is being used on its work order, can review previous work orders and present work orders, be notified of action taken by the vendor and to add information to the work order.

The system can handle a large number of vendors each with its own group of customers. Any customer can be providing work orders to two or more vendors on the same system and the system operator provides each customer with a separate ID for each vendor it interacts with. Each vendor, likewise, has a separate ID or URL assigned by the system operator. The vendor can check invoices from the operator, run four different types of reports, can modify information about itself visible to the customers, add and delete certain of its employees for access to the system and select which portions of the system each of those employees has access to, create customer accounts, ascertain what equipment is available for each work order and what labor, whether in-house or contract, schedule preventive maintenance on each piece of equipment, see the status of all work orders and modify them if need be and review work order history.

The vendor can modify the user ( customer) screens and create new ones. It can review the names and identification of each piece of equipment it has available for certain work orders and assign them while also setting up a maintenance timetable, review the record of customer payments, edit comments on each customer profile and create new work orders. It can search the orders for a key word in each text, establish unit and total cost of materials associated with each work order, establish urgency of completion of the work order, and cause e-mail to be sent to the customer employee advising them of changes, progress, etc.

Accordingly it is an object of this invention of this invention to provide an on-line work order management system for vendors and customers,

It is another object of this invention to provide a work order system which provides a low cost alternative to expensive IT systems for small and medium sized vendors and customer,

It is yet another object of this invention to provide a private work order system for a plurality of vendors on the same on-line system,

Still another object of this invention is to provide a work order management system where the customers can enter the orders themselves and which is accessible from any web browser,

A further object of this invention is to provide a work order management system for vendors who can select which of its employees have access to selected portions of the system for various purposes,

A still further object of this invention is to provide a work order management system for vendors who can update company information, establish customer accounts and add employees and/or equipment to each customer work order, and to schedule preventive maintenance on its equipment.

Another object is to provide a work management system for Vendors or companies to manage internal work orders allowing them to manage their business

Still another object is to provide for the automatic generation of preventive maintenance with e-mail notification of work cue.

Yet another object of this invention is to provide an on-line work order management systems for vendors which allows customers to logon for entering work orders and which allows the vendor to modify and add to the work order at the direct request of a customer employee.

Furthermore, it is another object of this invention to provide a unique on-line work order management system for generating reports to the vendor and invoice reports to the system operator.

These and other objects of the invention will become apparent when reference is had to the accompanying drawings in which;

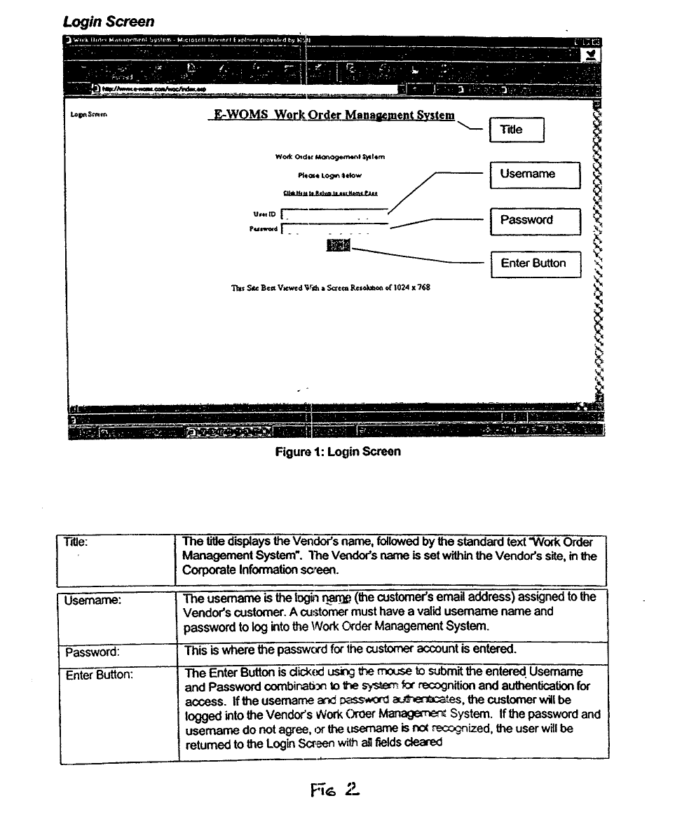

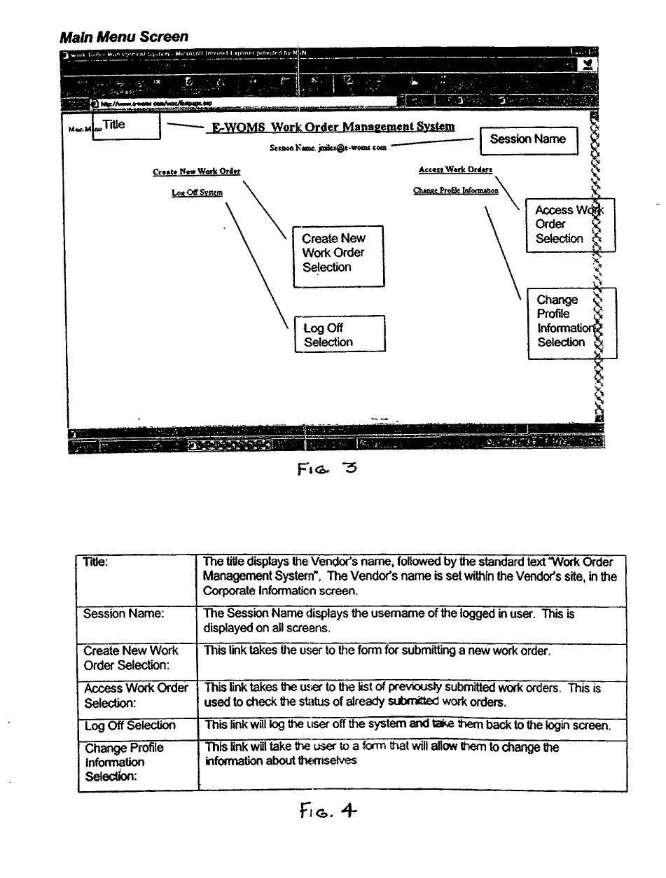

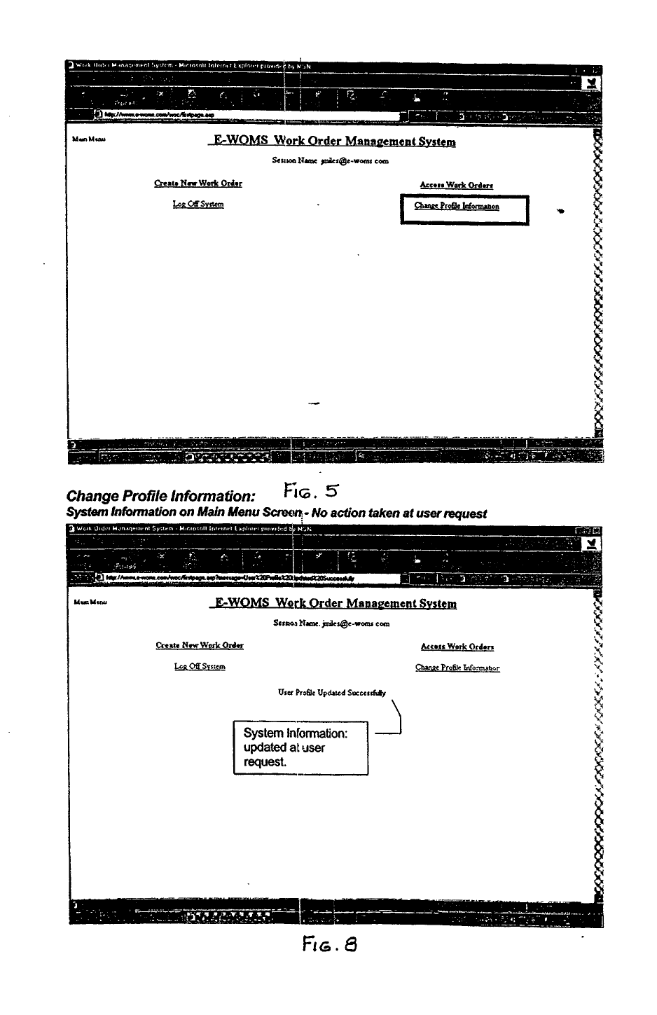

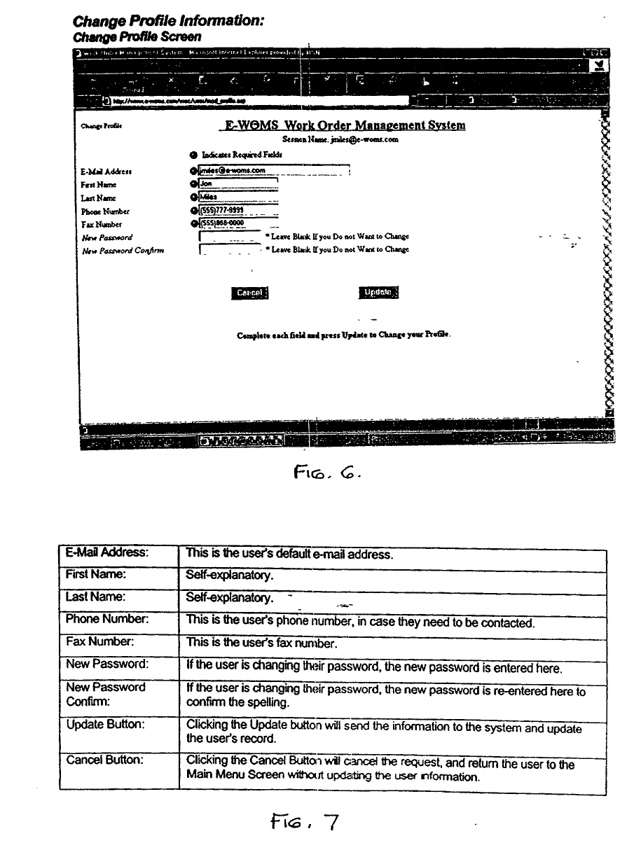

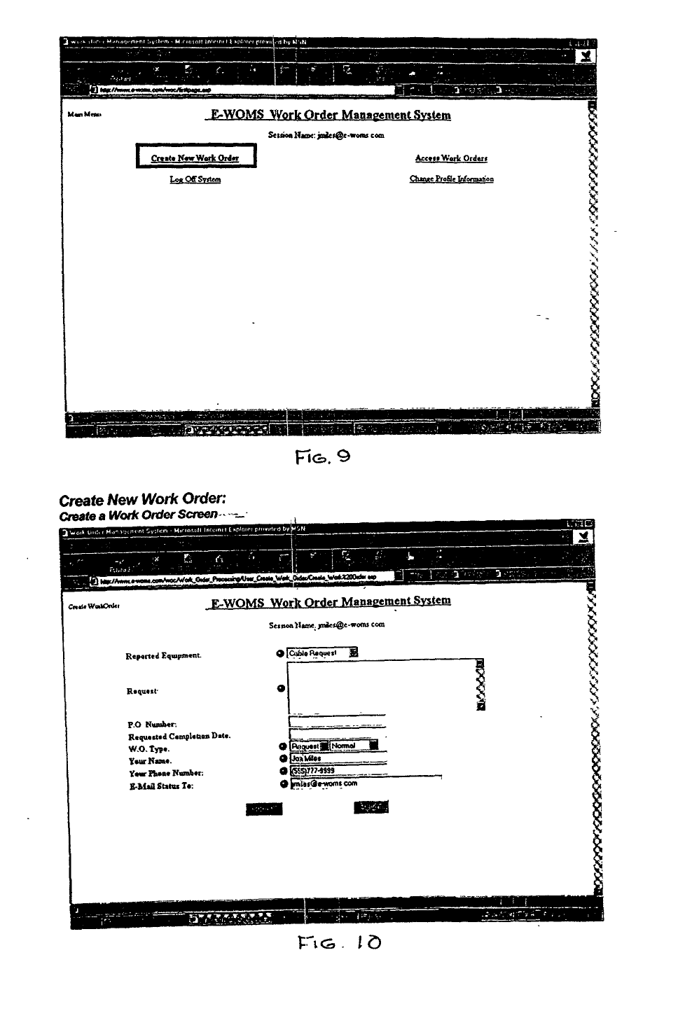

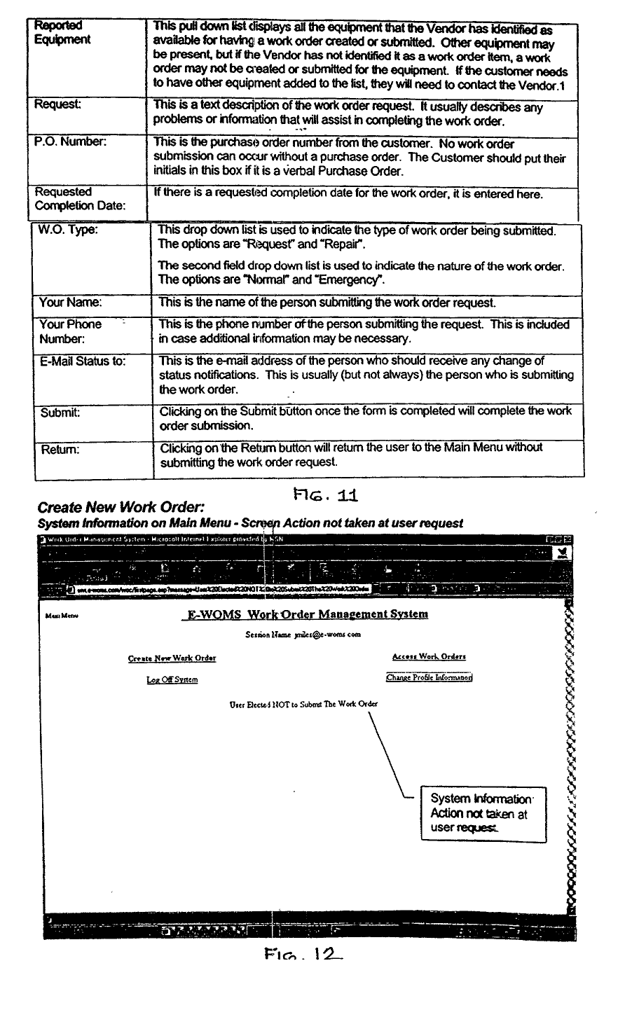

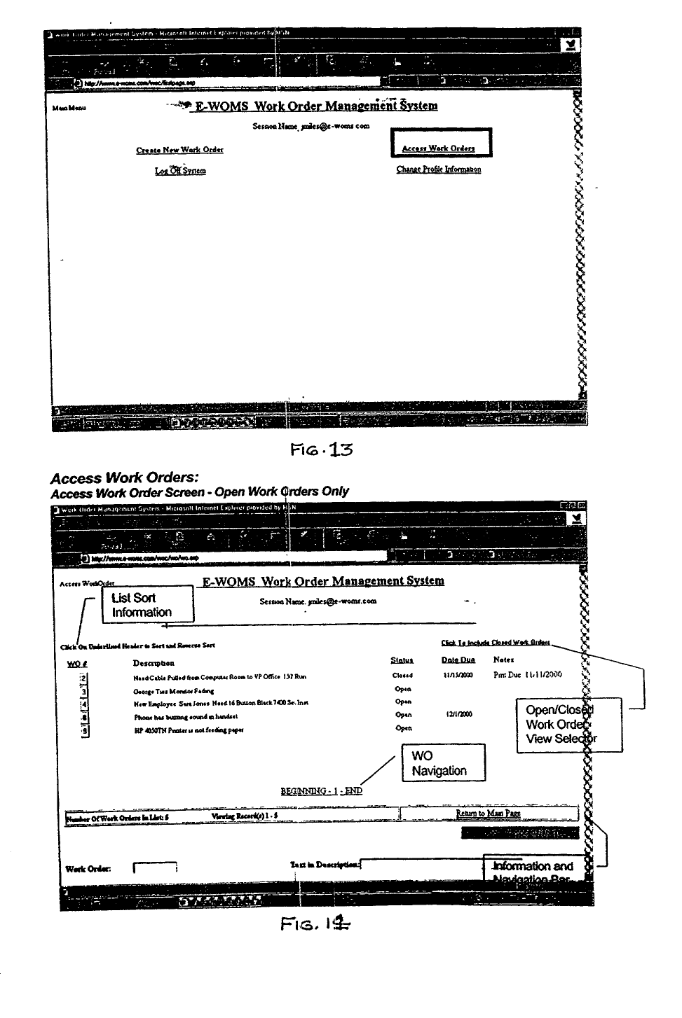

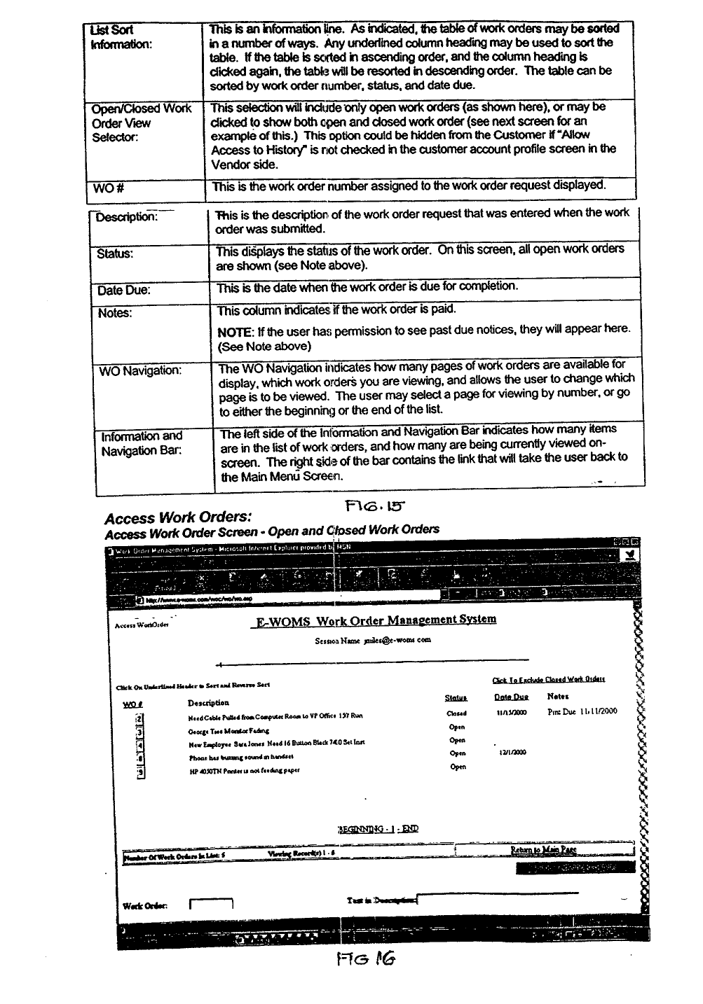

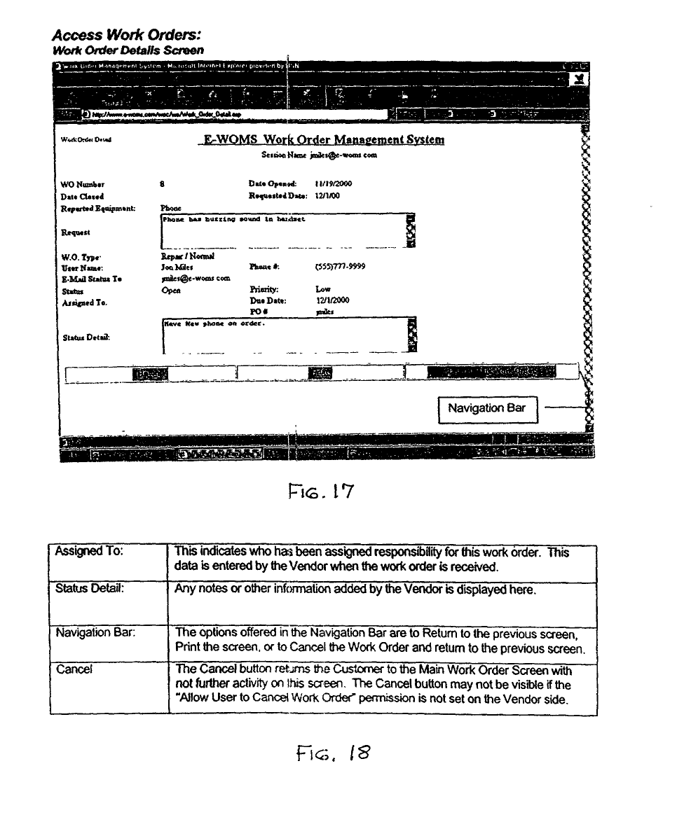

FIG. 1 is a customer login screen,

FIG. 2 is a table accompanying FIG. 1,

FIG. 3 is the customer main menu screen,

FIG. 4 is a table accompanying FIG. 3,

FIG. 5 is a customer user profile screen,

FIG. 6 is customer change profile screen,

FIG. 7 is a table accompanying FIG. 6,

FIG. 8 is a customer change profile information screen,

FIG. 9 is customer work order screen,

FIG. 10 is a customer create a work order screen,

FIG. 11 is a table accompanying FIG. 10,

FIG. 12 is a customer system information on main menu screen,

FIG. 13 is a customer access work order screen,

FIG. 14 is customer open work order only screen,

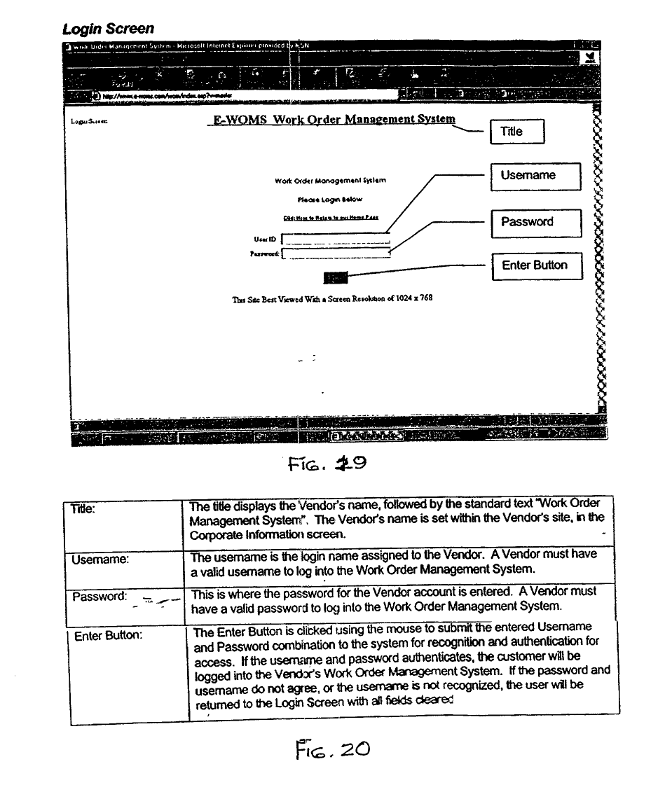

FIG. 15 is a table accompanying FIG. 14,

FIG. 16 is a customer open and closed work order screen,

FIG. 17 is a customer work order details screen,

FIG. 18 is a table accompanying FIG. 17,

FIG. 19 is a vendor login screen,

FIG. 20 is a table accompanying FIG. 19,

FIG. 21 is a main menu screen for the vendor,

FIG. 22 is a table accompanying FIG. 21,

FIG. 23 is a vendor work with corporate information screen,

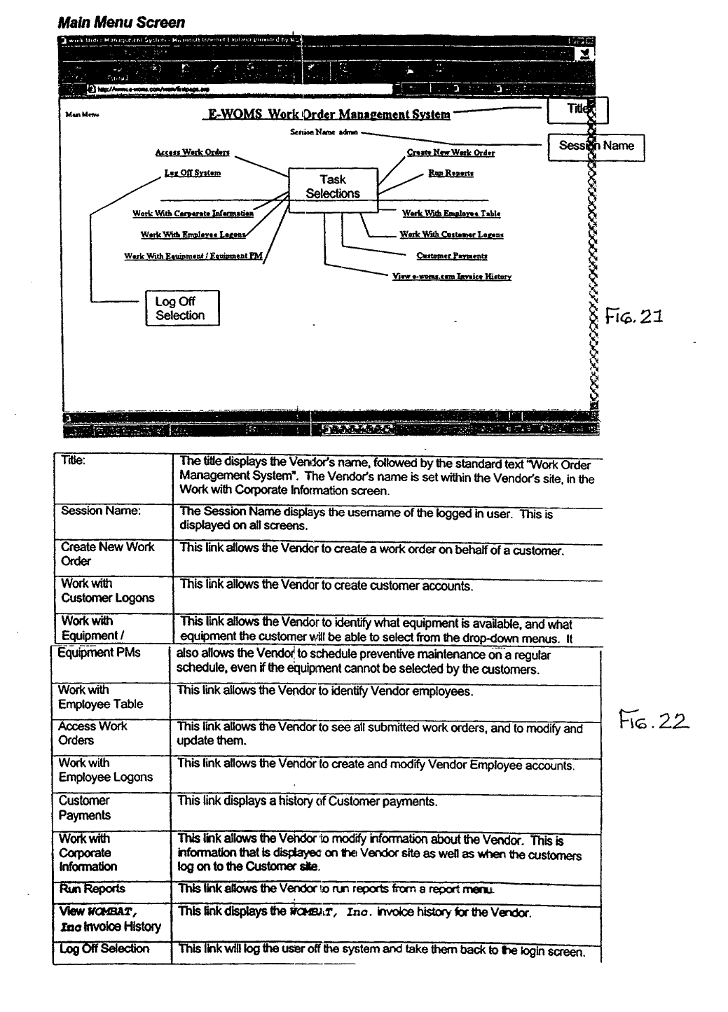

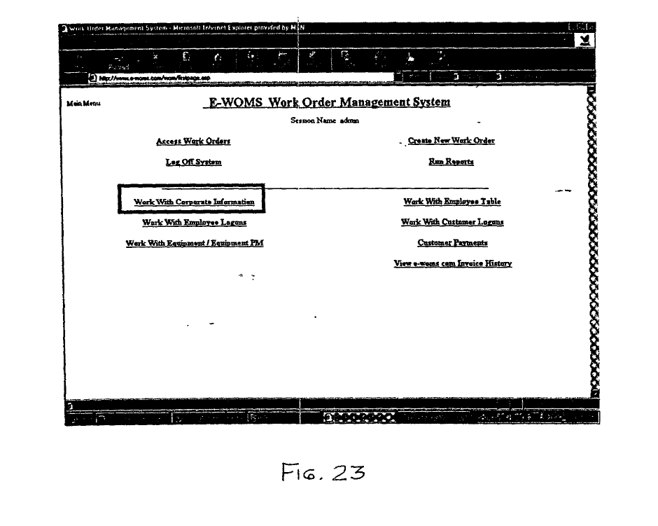

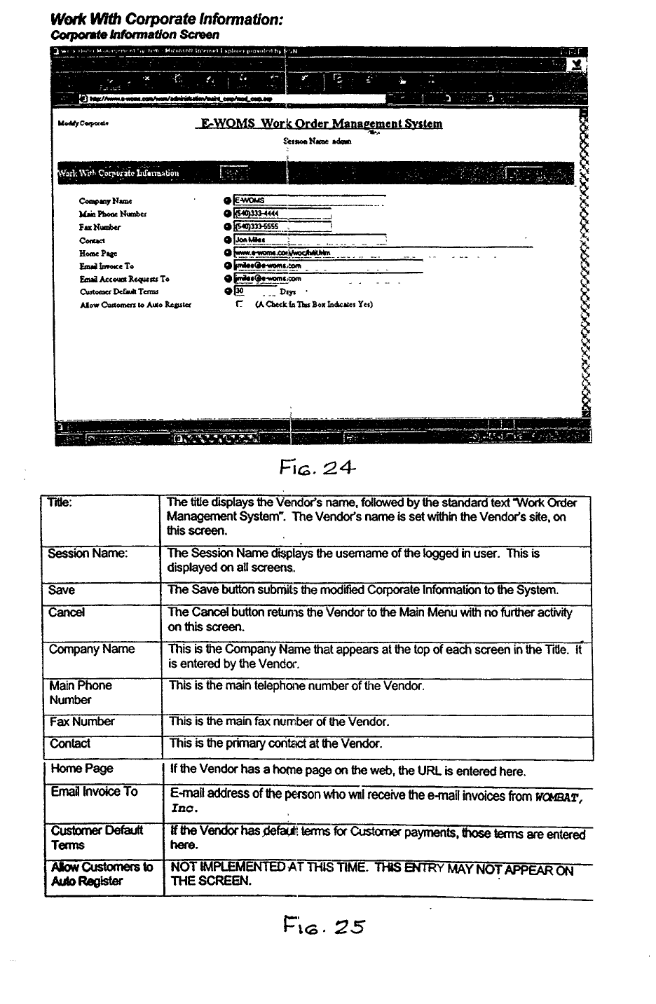

FIG. 24 is a vendor corporate information screen,

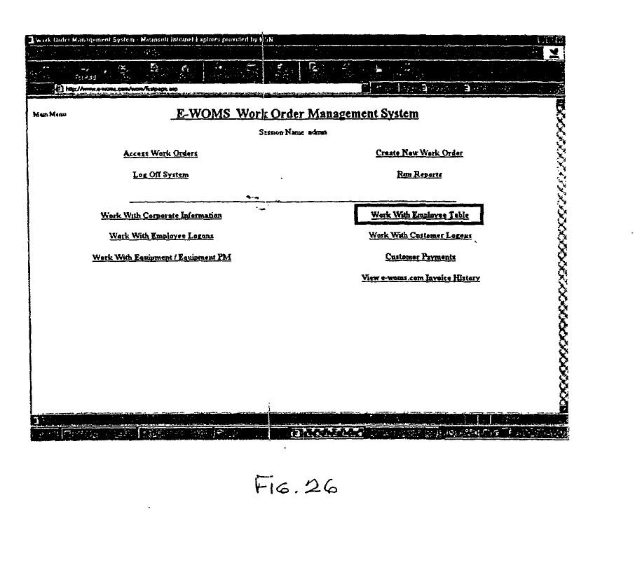

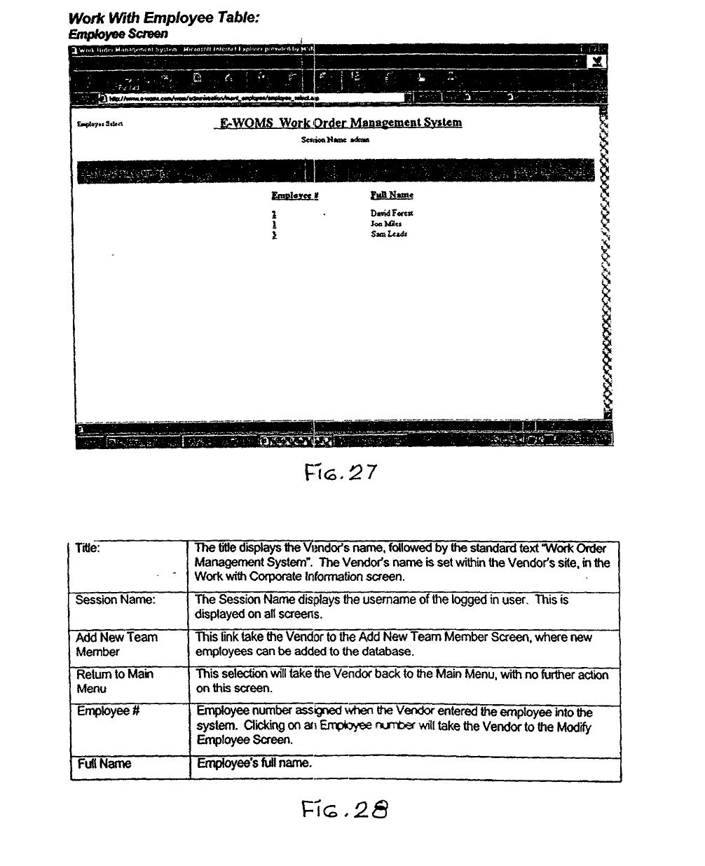

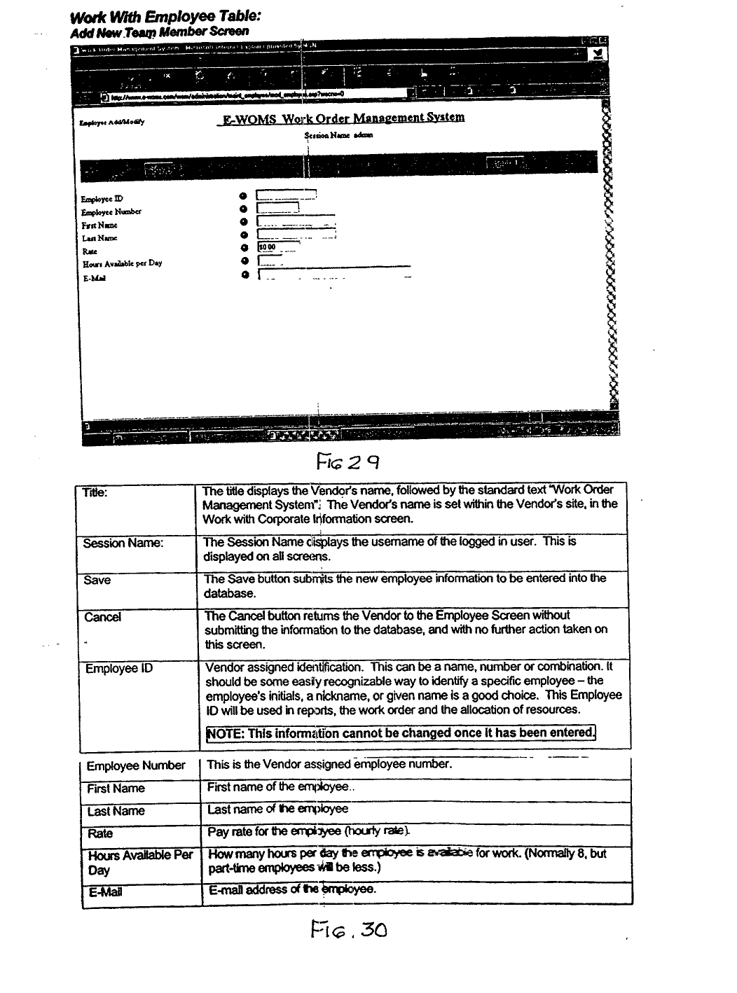

FIG. 25 is a table accompanying FIG. 24,

FIG. 26 is a vendor work with employee table,

FIG. 27 is a vendor employee screen,

FIG. 28 is a table accompanying FIG. 27,

FIG. 29 is a vendor add new team member screen,

FIG. 30 is a table accompanying FIG. 29,

FIG. 31 is a vendor modify employee screen,

FIG. 32 is a table accompanying FIG. 31,

FIG. 33 is a vendor work with employees screen,

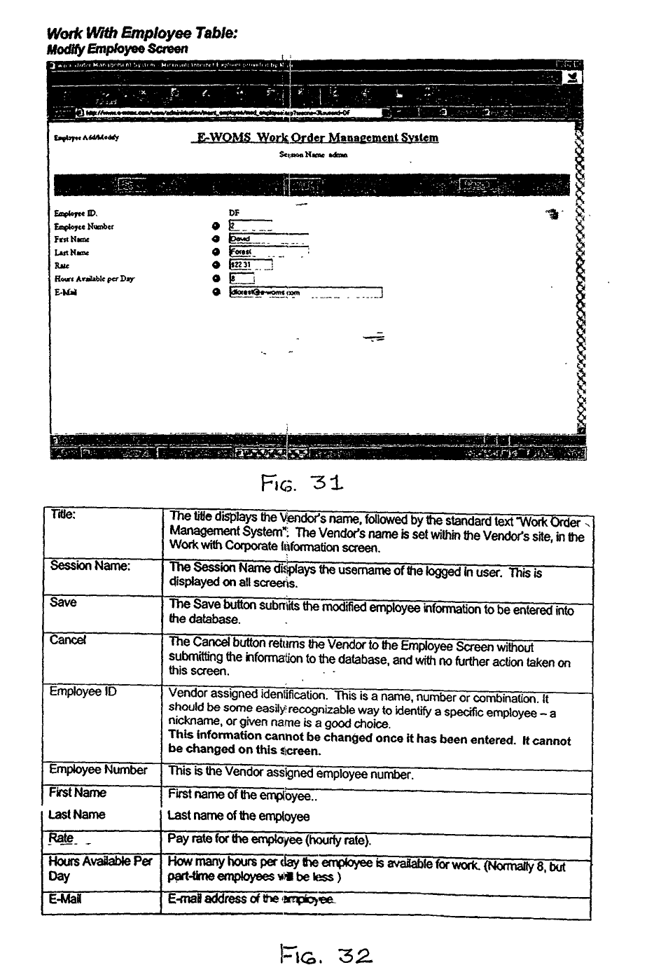

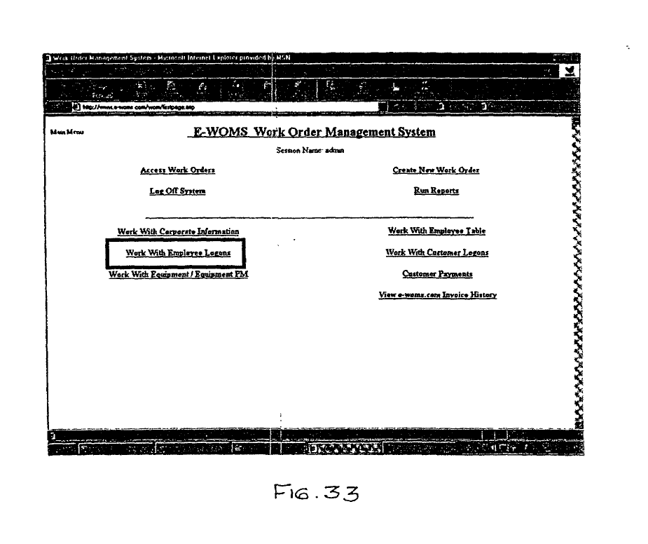

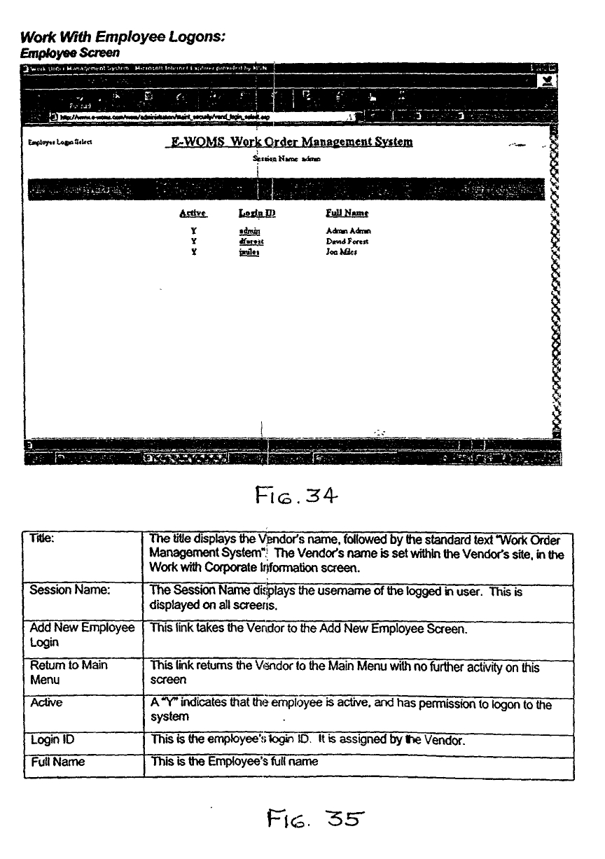

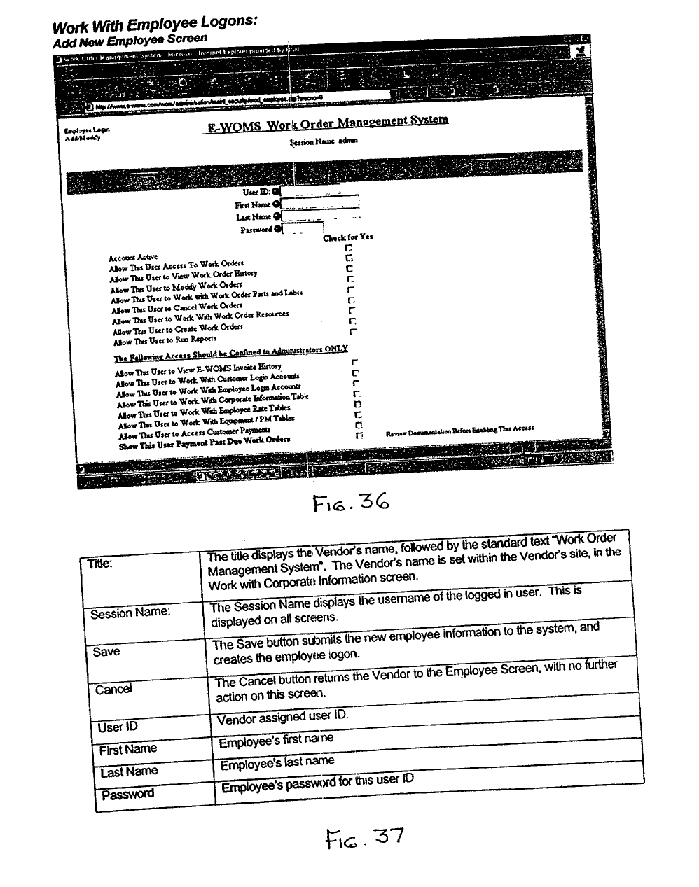

FIG. 34 is a vendor employee screen,

FIG. 35 is a table accompanying FIG. 34,

FIG. 36 is vendor add new employee screen,

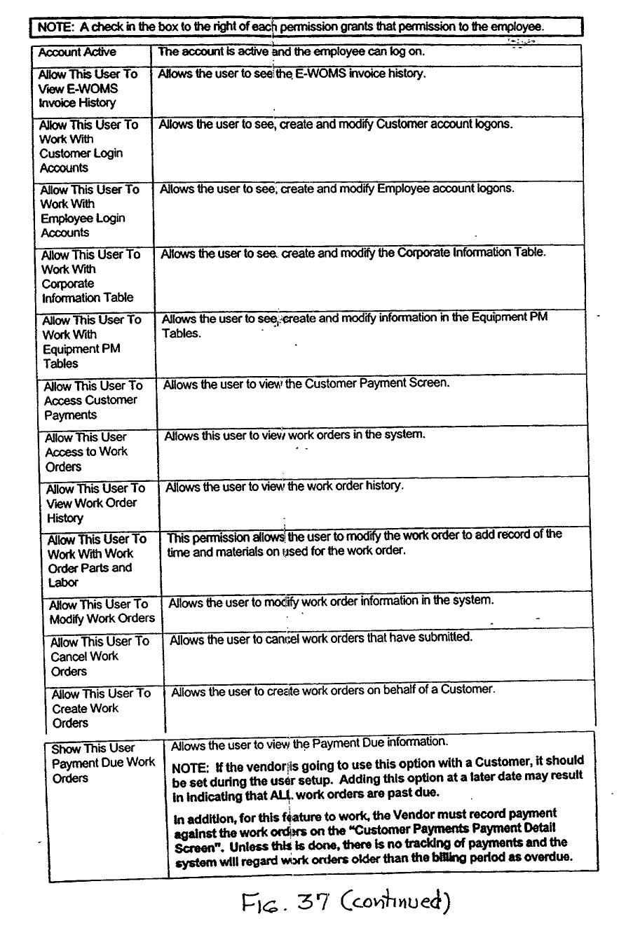

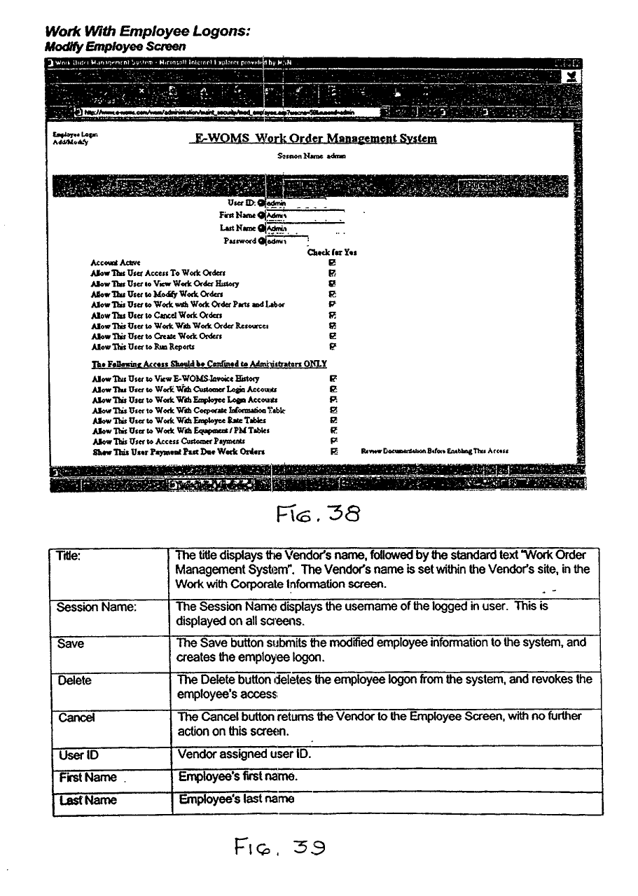

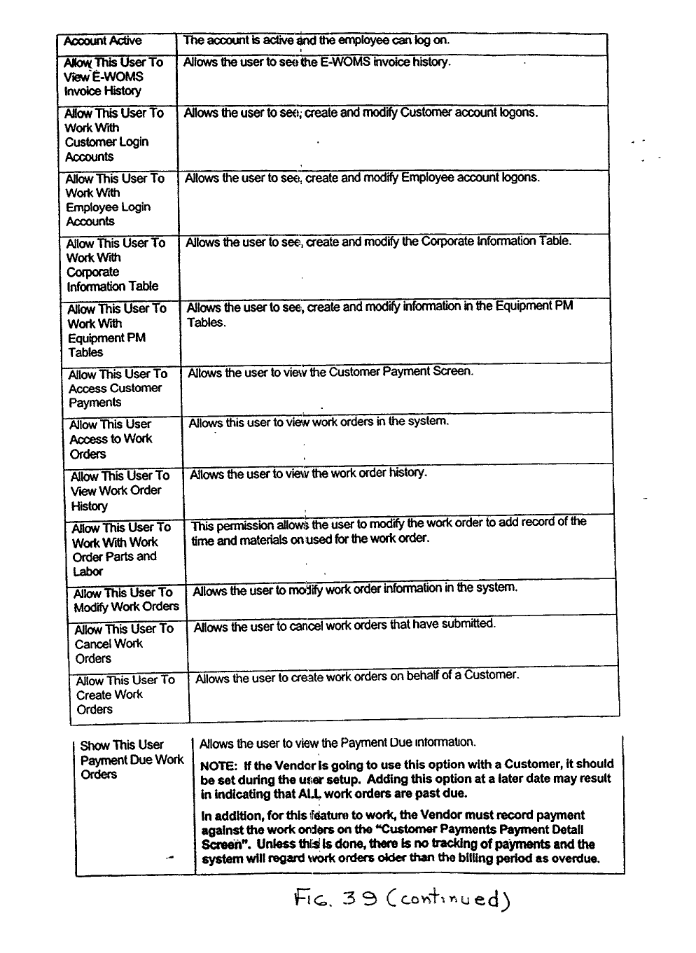

FIG. 37 is a table accompanying FIG. 36,

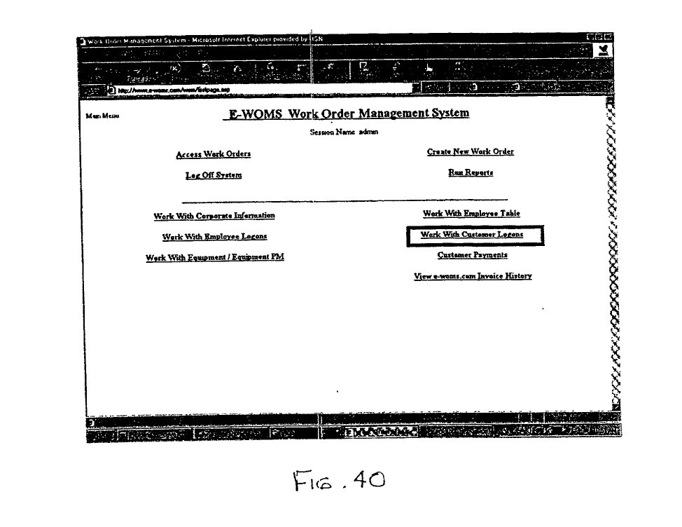

FIG. 38 is a vendor modify employee screen,

FIG. 39 is a table accompanying FIG. 38,

FIG. 40 is a vendor work with customer logon screen,

FIG. 41 is a customer selection screen,

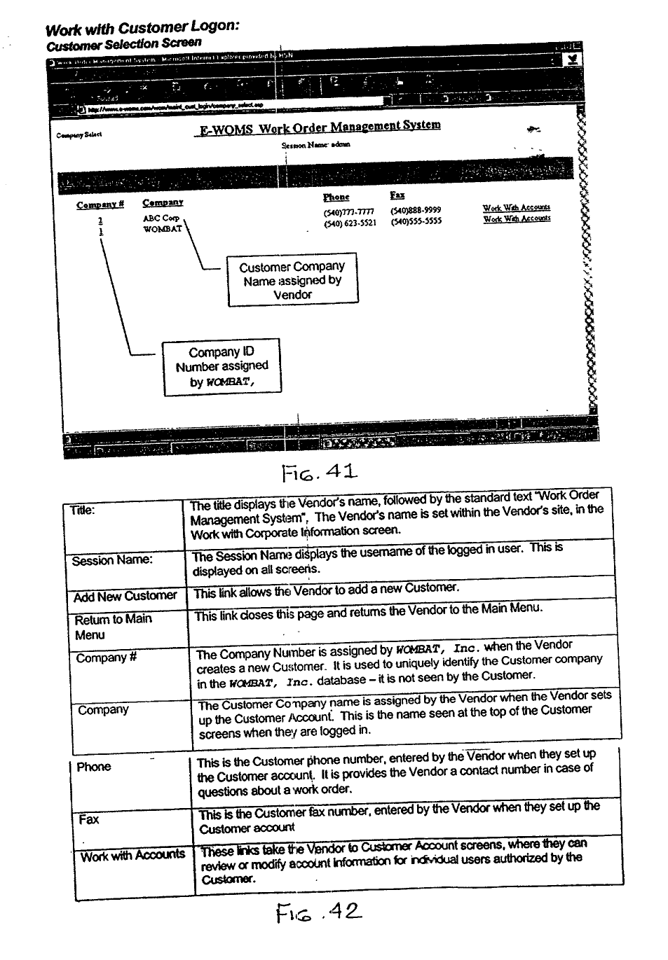

FIG. 42 is a table associated with FIG. 41,

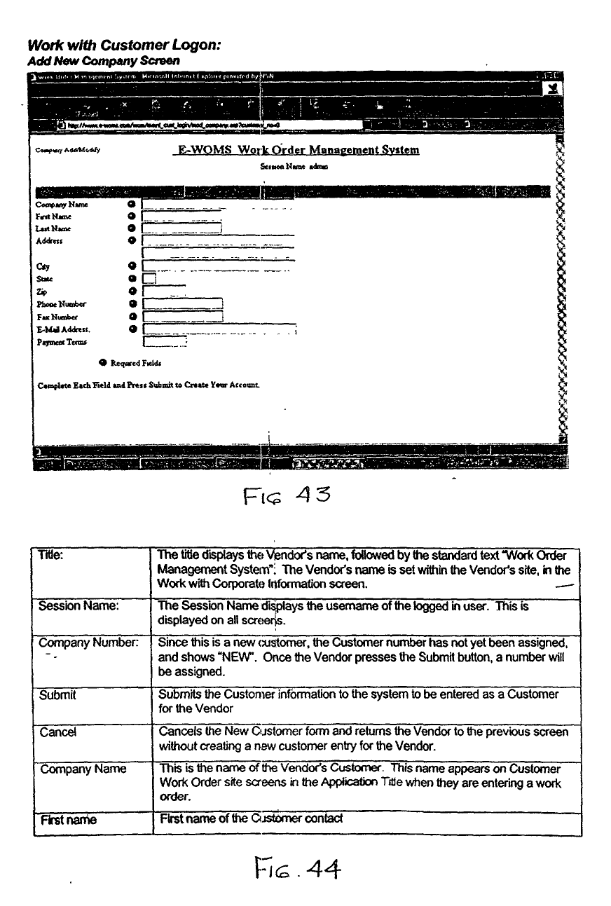

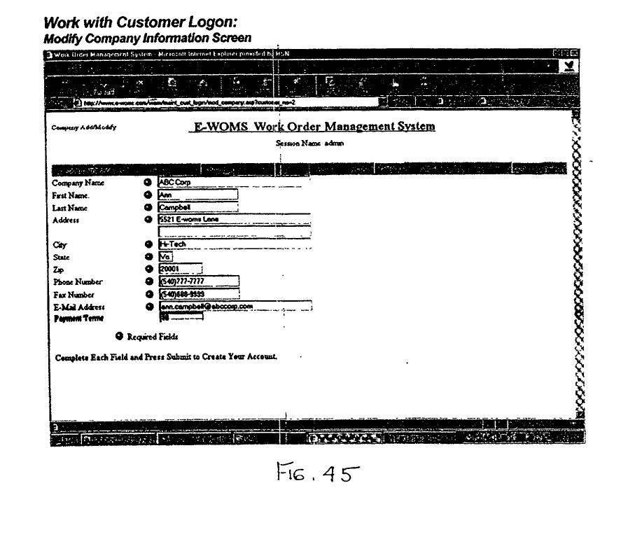

FIG. 43 is a vendor add new company screen,

FIG. 44 is a table accompanying FIG. 43,

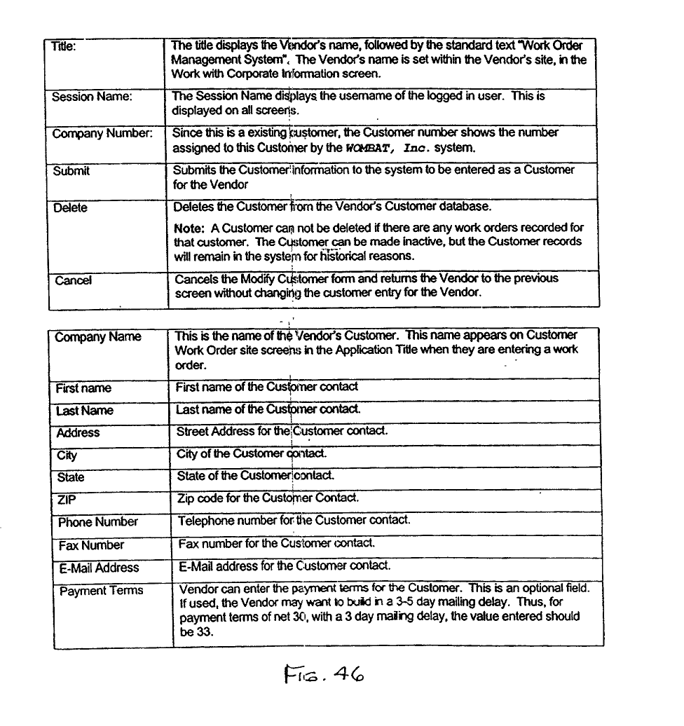

FIG. 45 is a vendor modify company information screen,

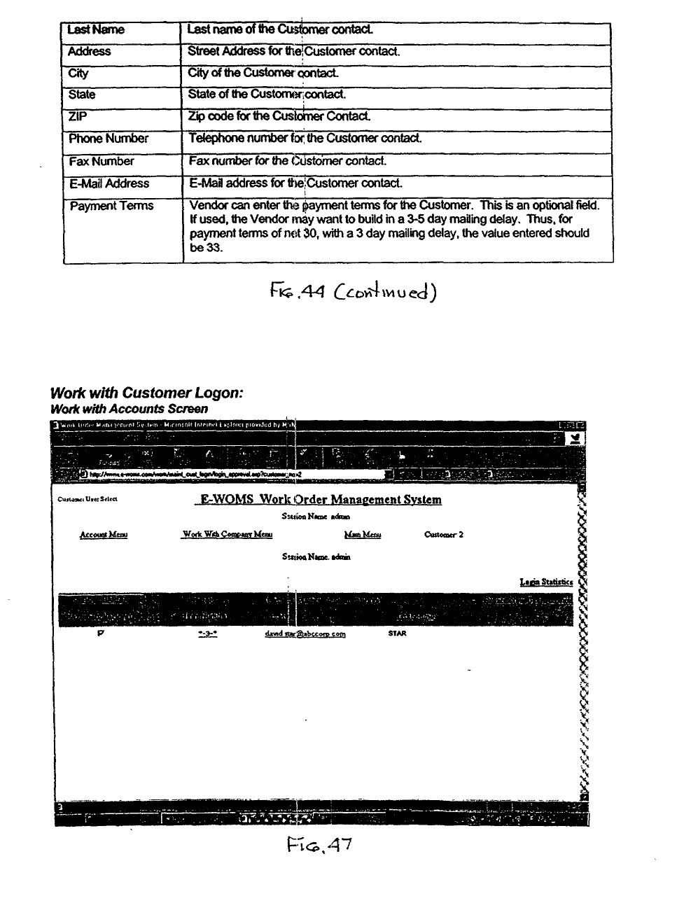

FIG. 46 is a table accompanying FIG. 45,

FIG. 47 is a vendor work with accounts screen,

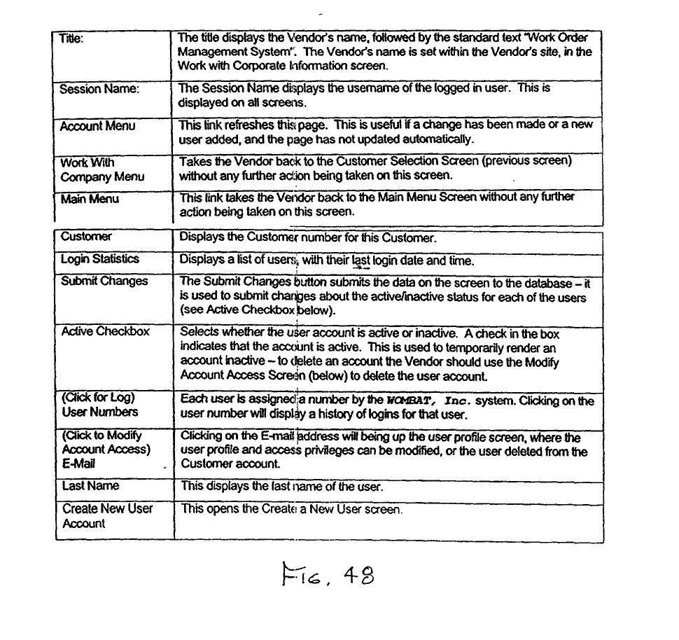

FIG. 48 is a table accompanying FIG. 47,

FIG. 49 is a vendor login statistics screen,

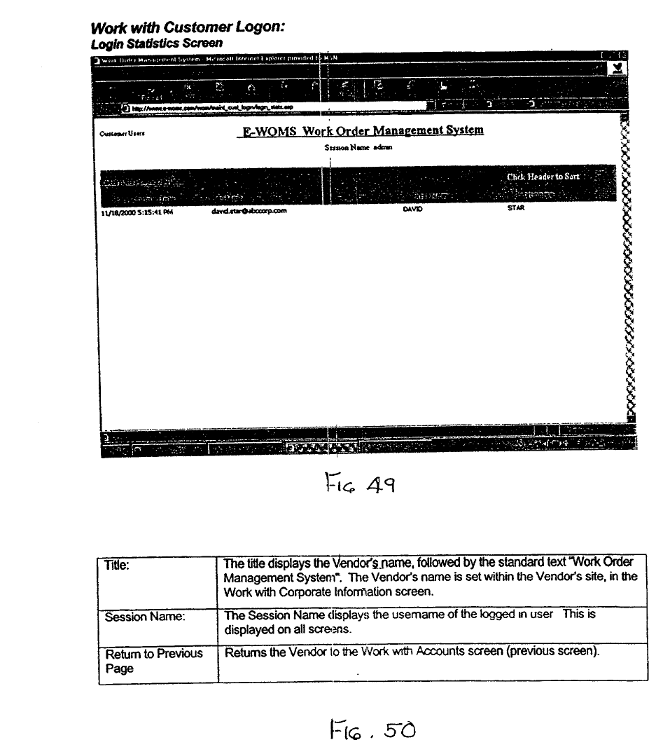

FIG. 50 is a table accompanying FIG. 49,

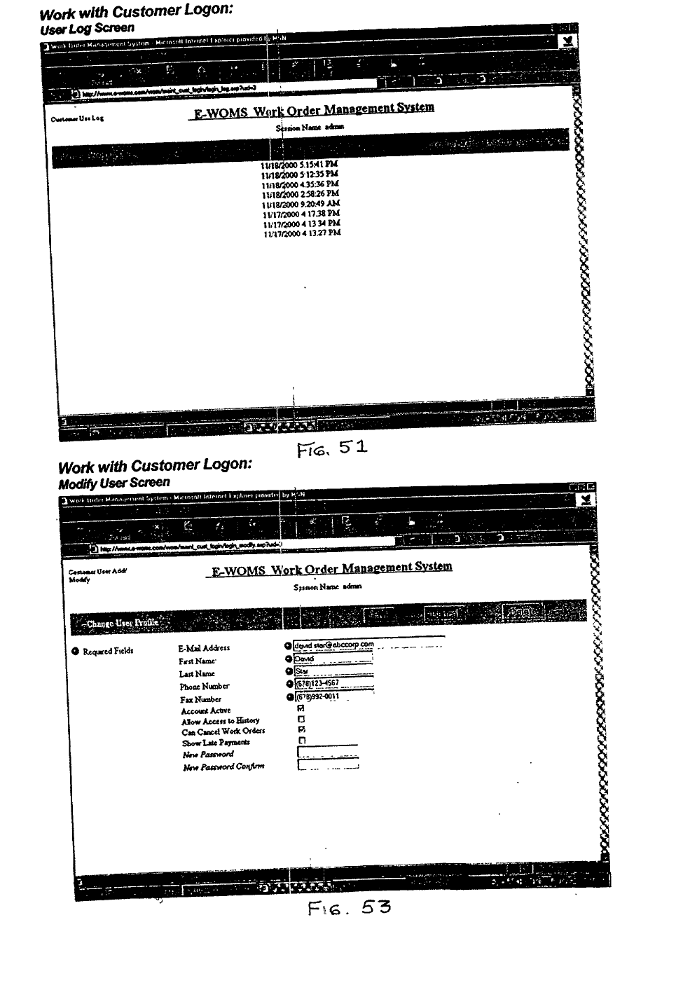

FIG. 51 is a vendor user log screen,

FIG. 52 is a table accompanying FIG. 51,

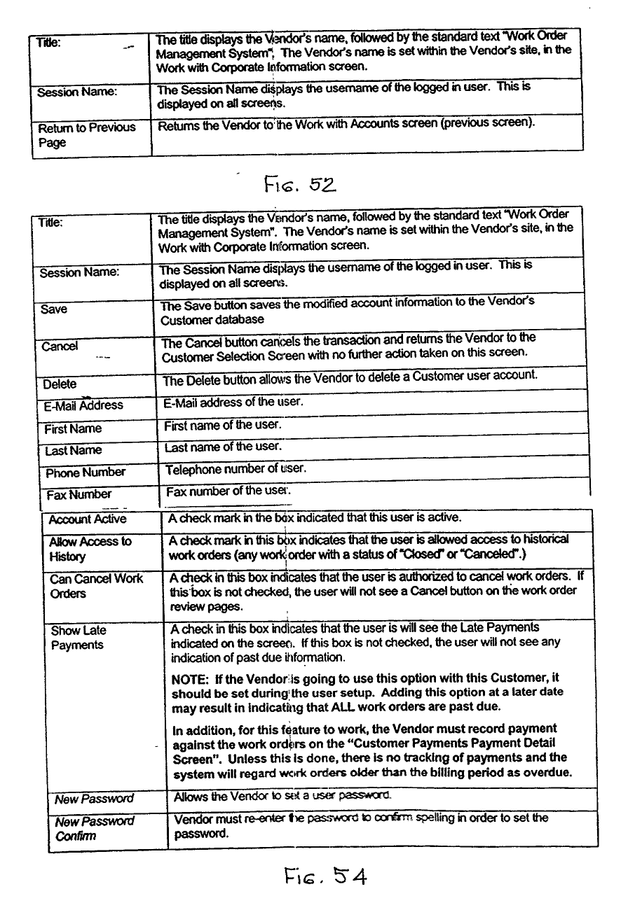

FIG. 53 is vendor modify user screen,

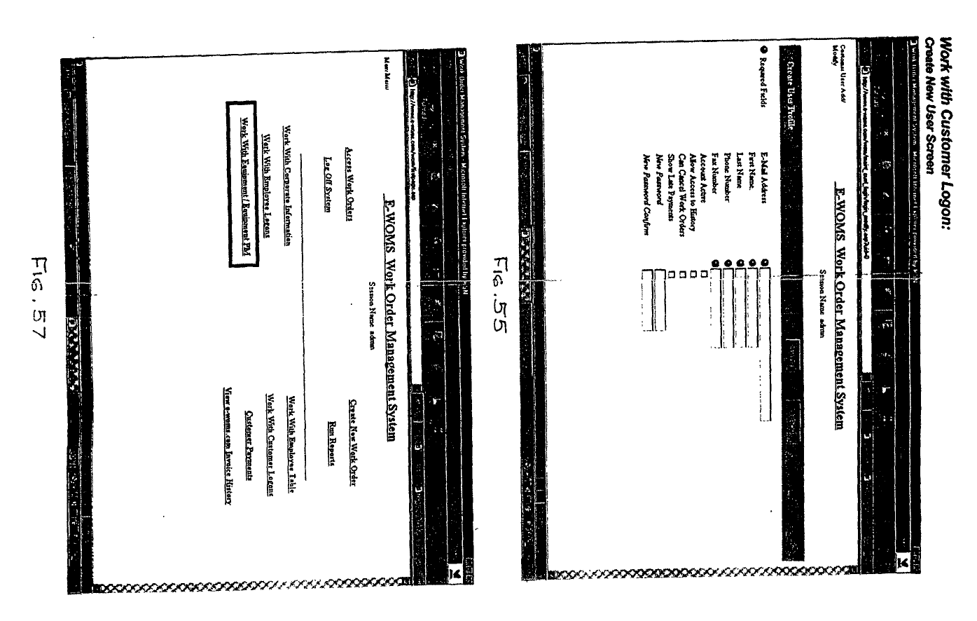

FIG. 54 is a table accompanying FIG. 53,

FIG. 55 is a vendor create new user screen,

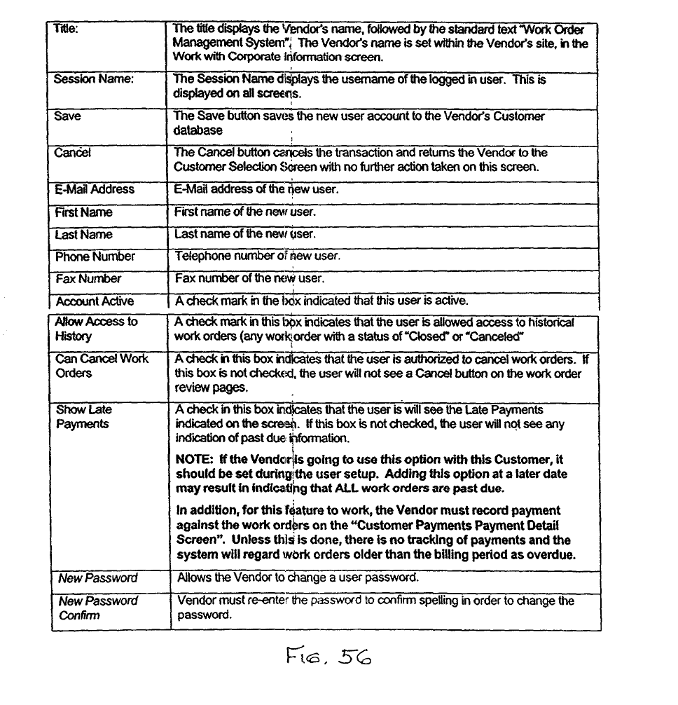

FIG. 56 is a table accompanying FIG. 55,

FIG. 57 is a vendor work with equipment screen

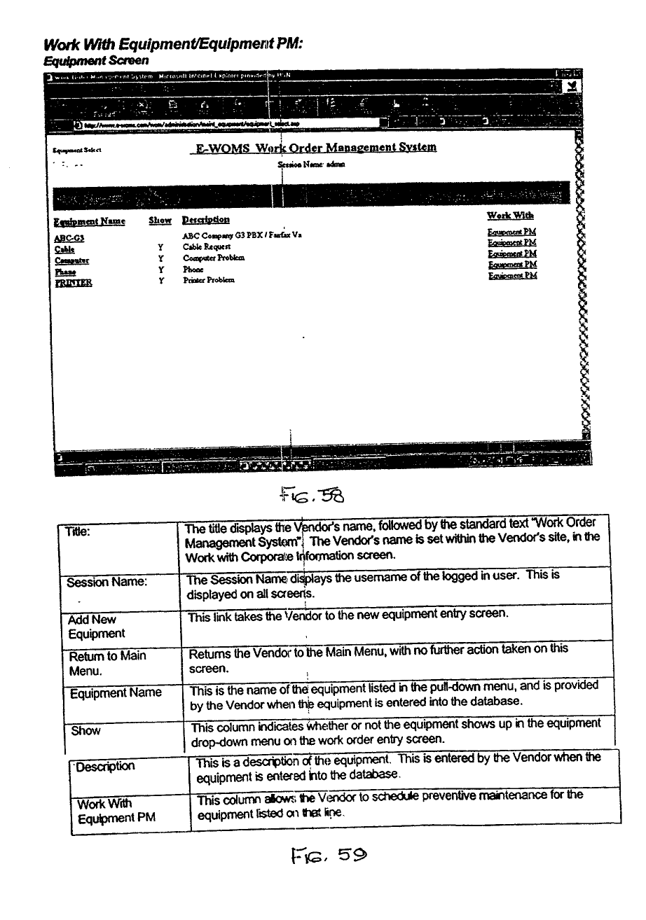

FIG. 58 is a vendor equipment screen,

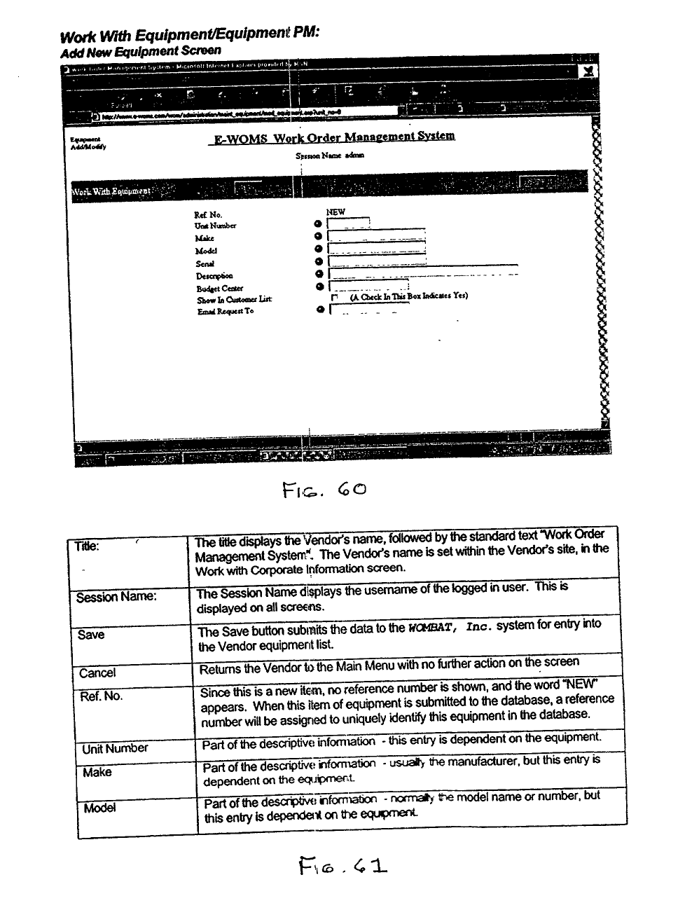

FIG. 59 is a table accompanying FIG. 58,

FIG. 60 is a vendor add new equipment screen,

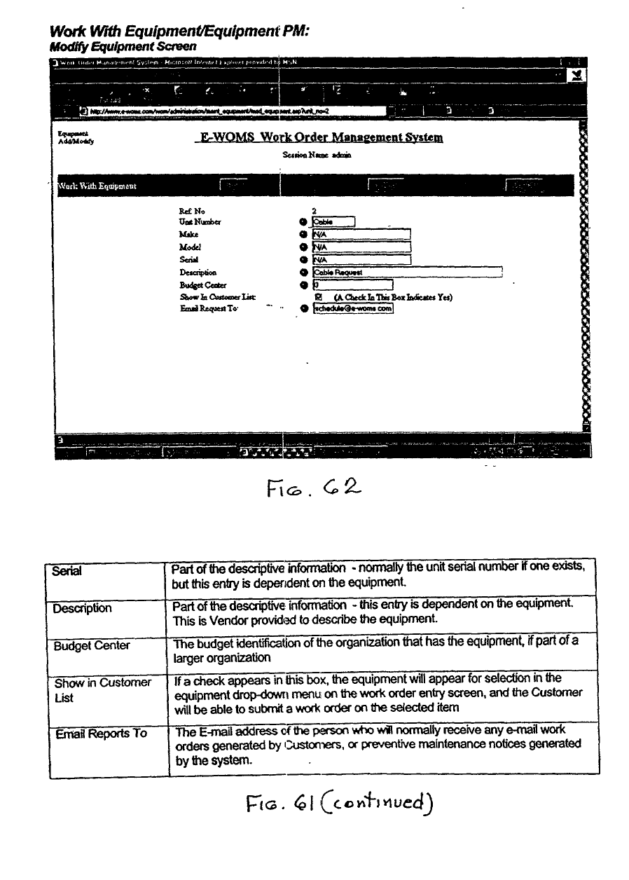

FIG. 61 is a table accompanying FIG. 60,

FIG. 62 is a vendor modify equipment screen,

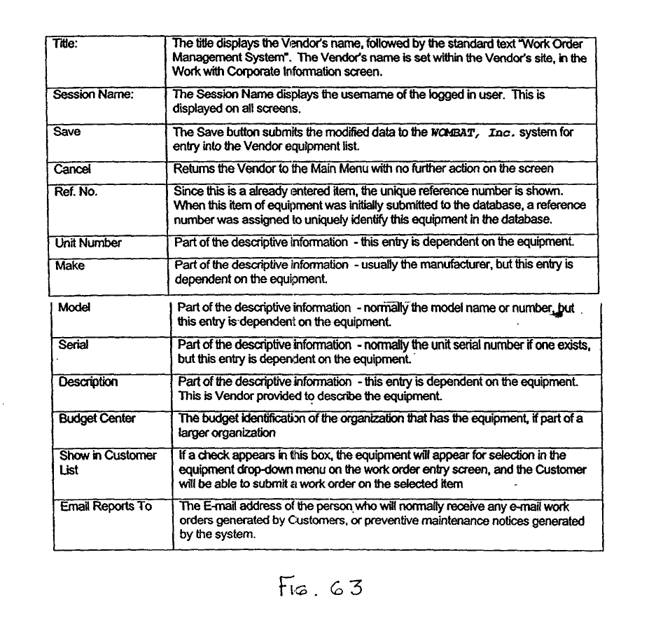

FIG. 63 is a table accompanying FIG. 62,

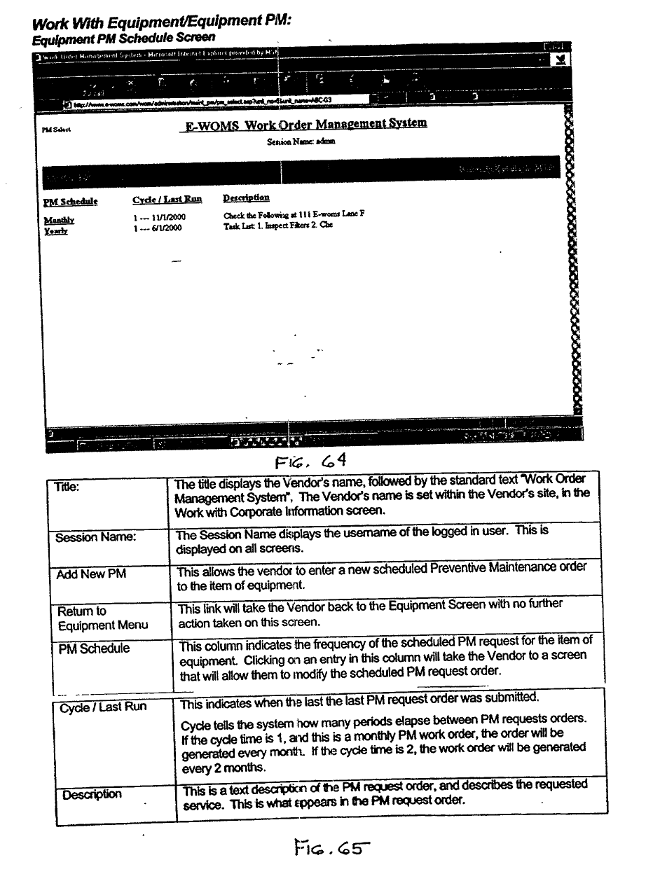

FIG. 64 is a vendor work with equipment/maintenance screen,

FIG. 65 is a table accompanying FIG. 64,

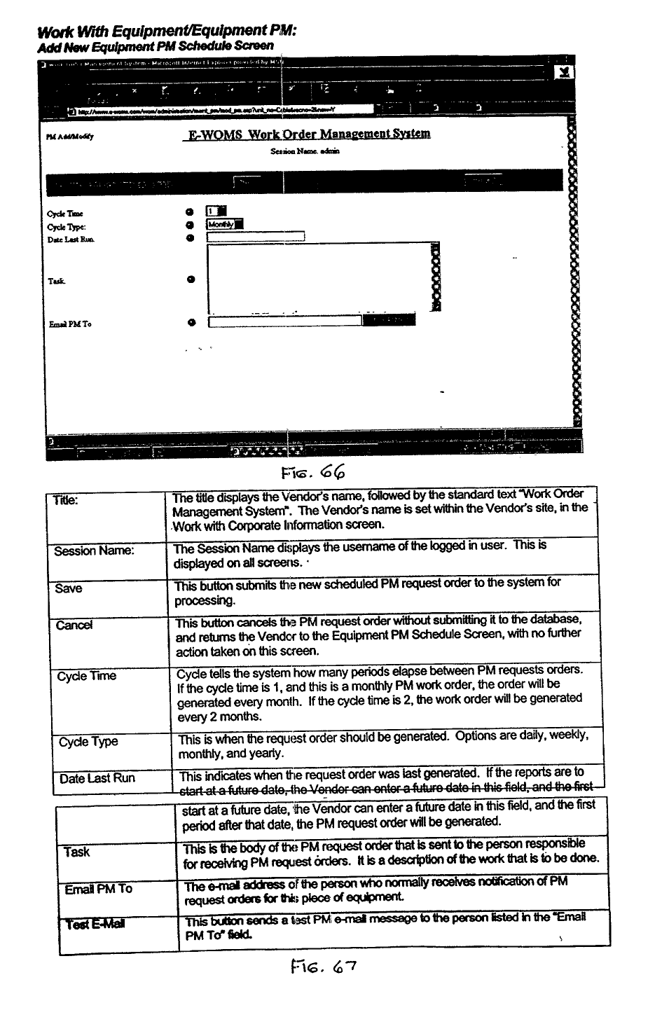

FIG. 66 is a vendor add new equipment screen,

FIG. 67 is a table accompanying FIG. 66,

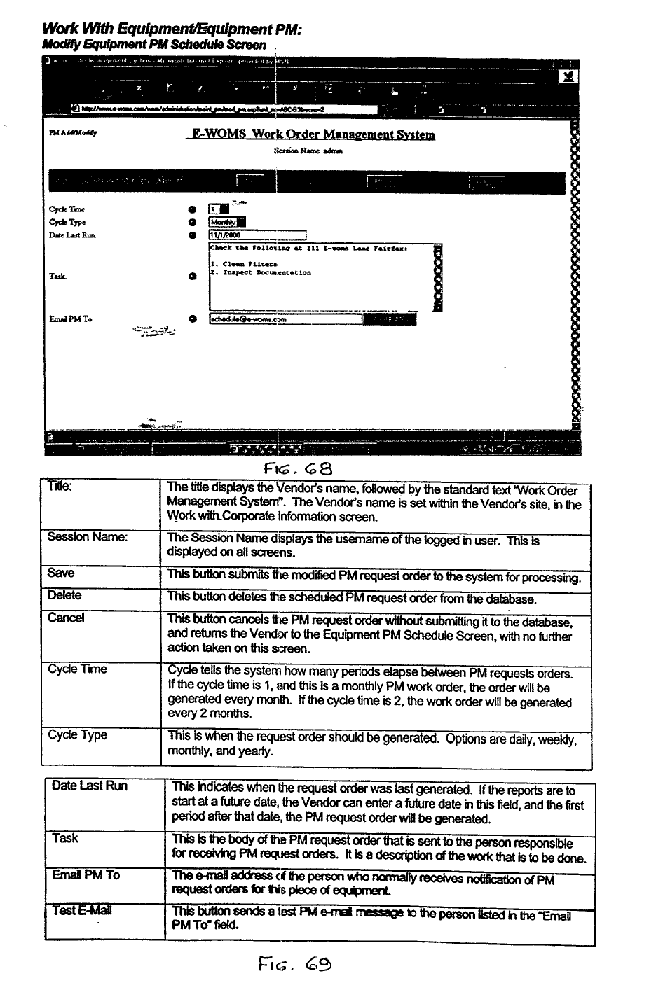

FIG. 68 is vendor modify equipment maintenance screen,

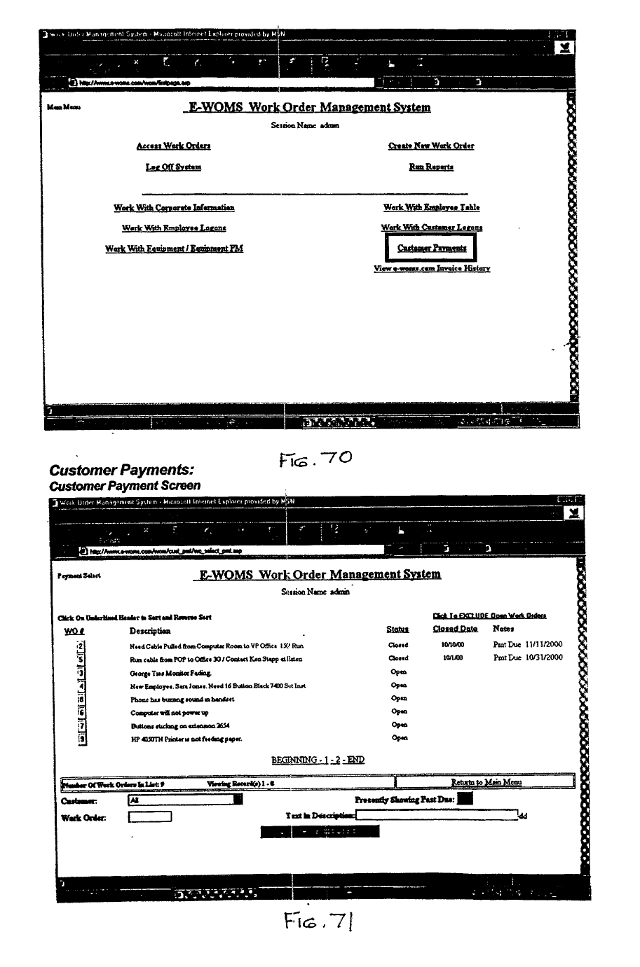

FIG. 69 is a table accompanying FIG. 68,

FIG. 70 is vendor customer payments screen,

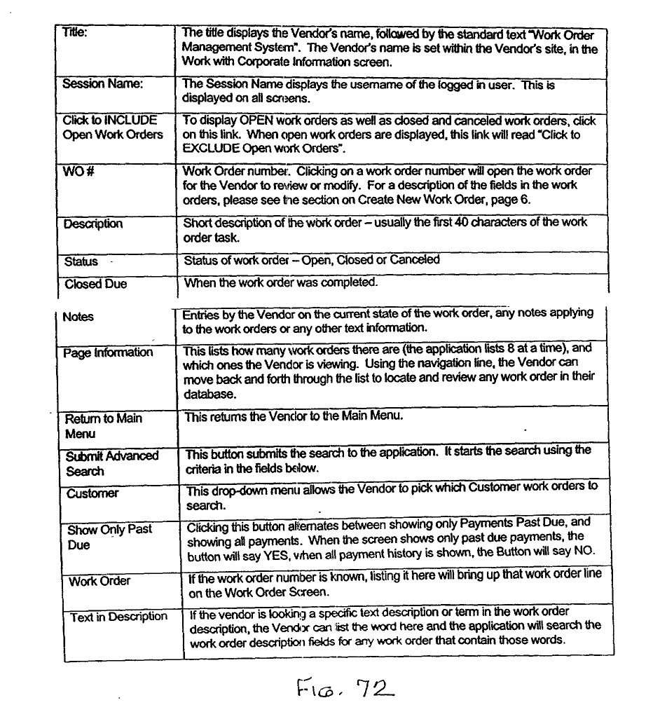

FIG. 71 is a vendor customer payment screen,

FIG. 72 is a table accompanying FIG. 71,

FIG. 73 is a vendor work order details screen,

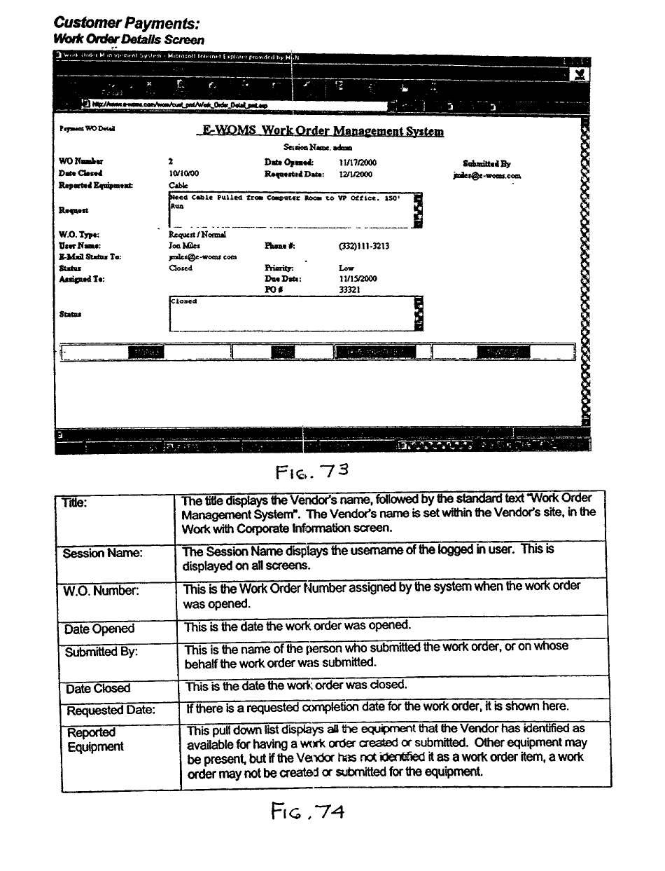

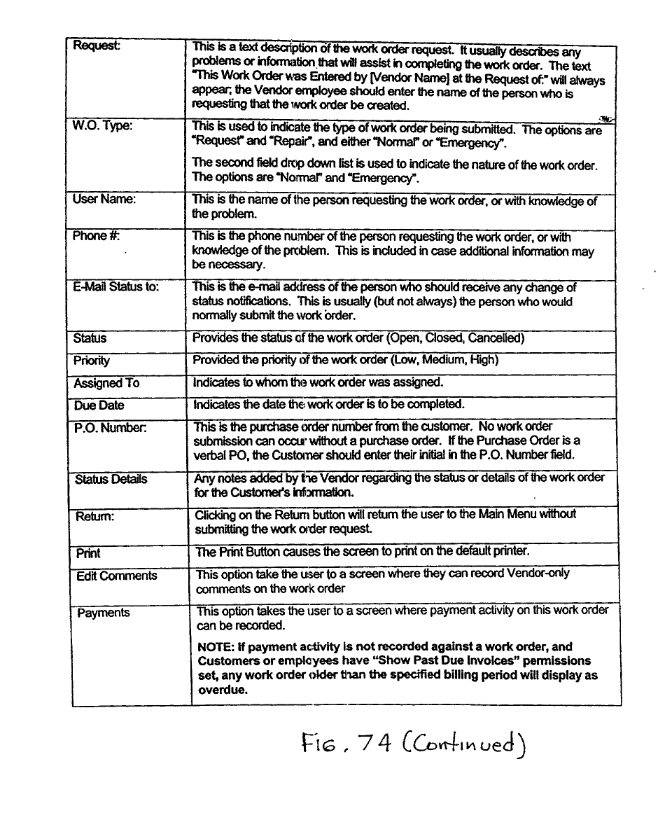

FIG. 74 is a cable accompanying FIG. 73,

FIG. 75 is a vendor edit comments screen,

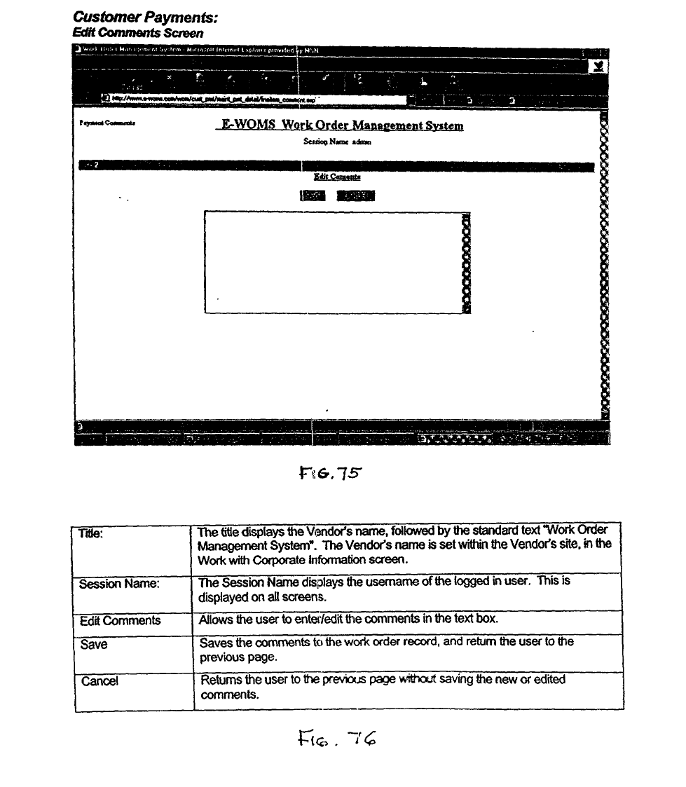

FIG. 76 is a table accompanying FIG. 75,

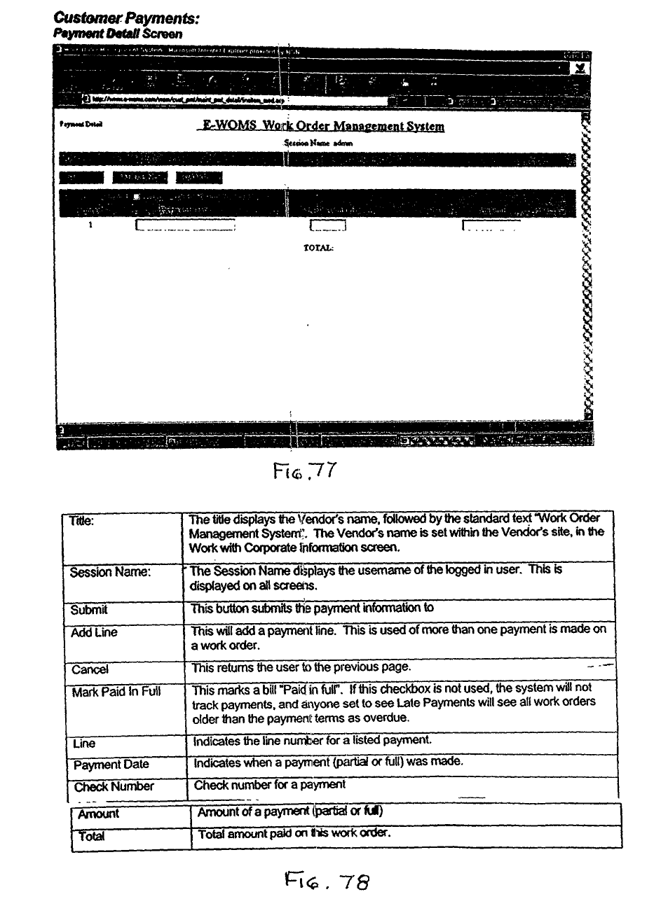

FIG. 77 is a vendor payment detail screen,

FIG. 78 is a table accompanying FIG. 77,

FIG. 79 is a vendor create new work order screen,

FIG. 80 is a vendor customer selection screen,

FIG. 81 is a table accompanying FIG. 80,

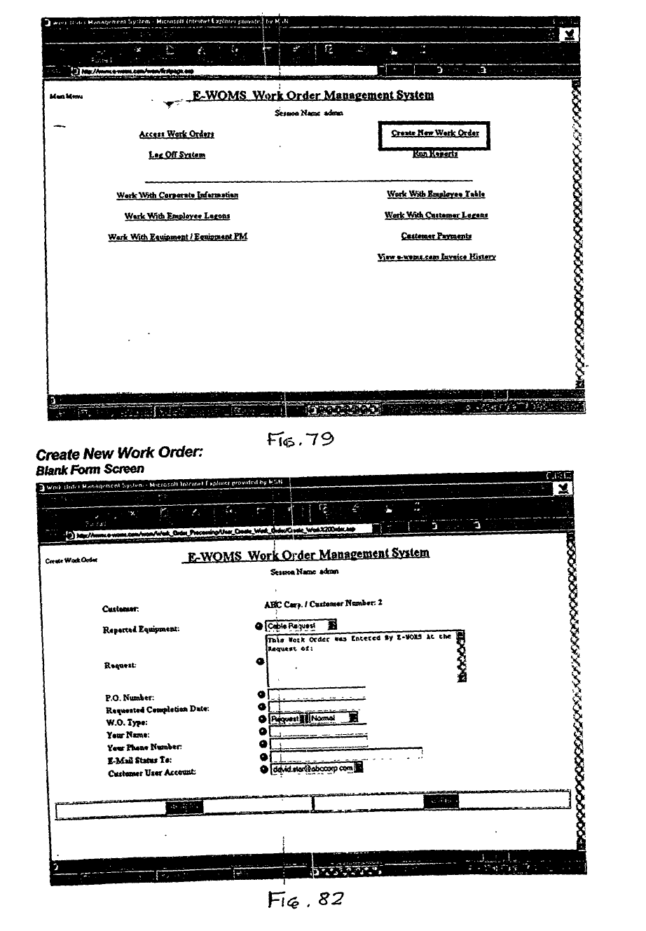

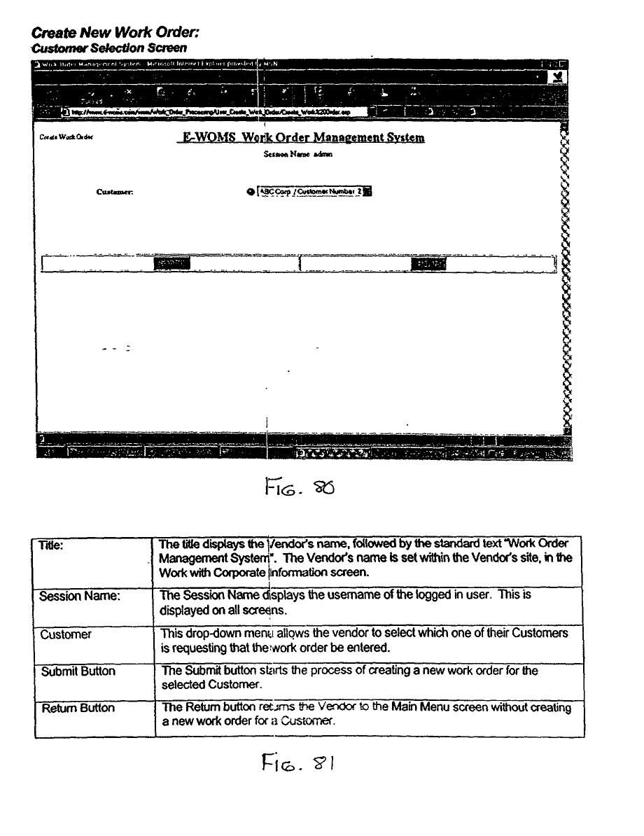

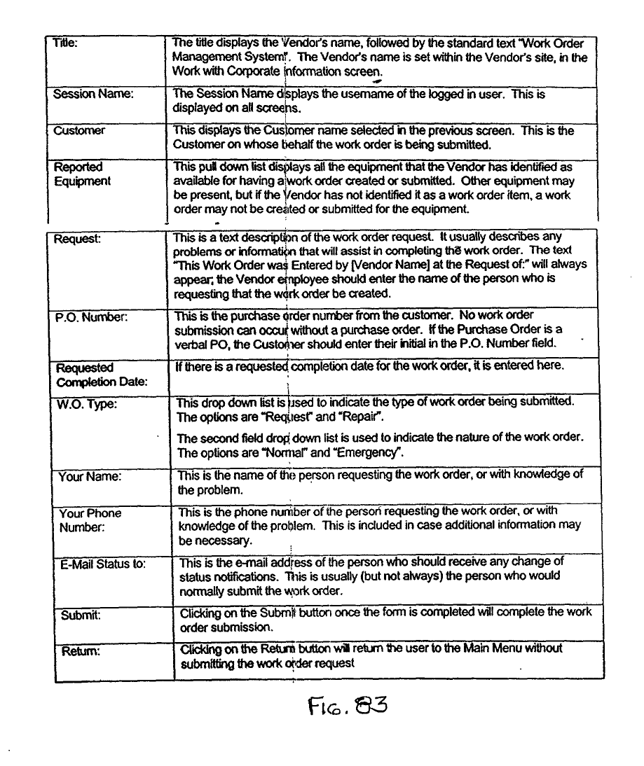

FIG. 82 is a vendor blank form screen,

FIG. 83 is a table accompanying FIG. 82,

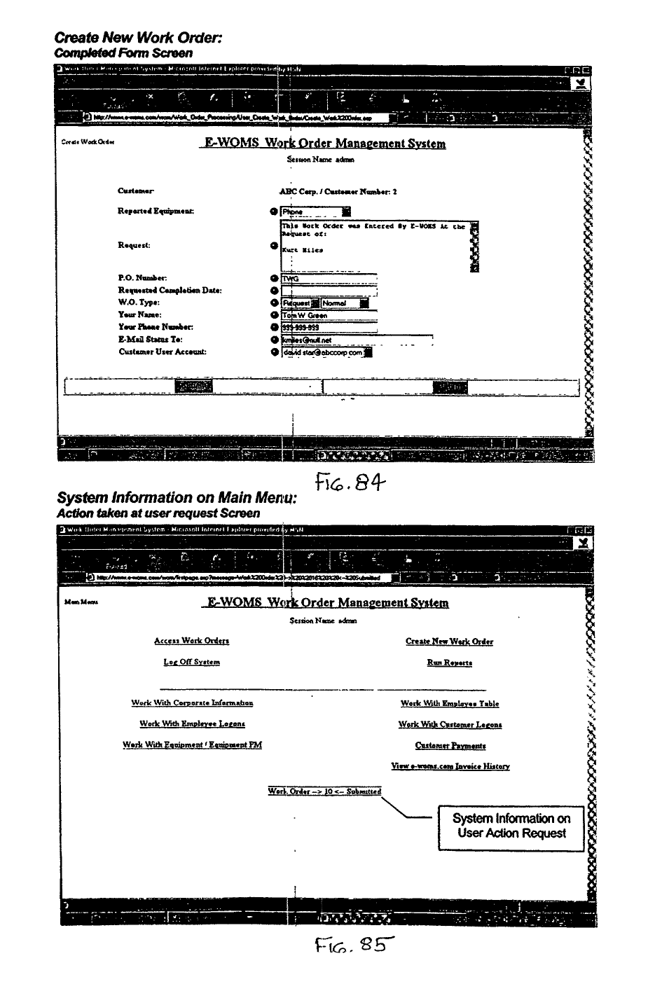

FIG. 84 is a vendor completed form screen,

FIG. 85 is a vendor action taken at user request screen,

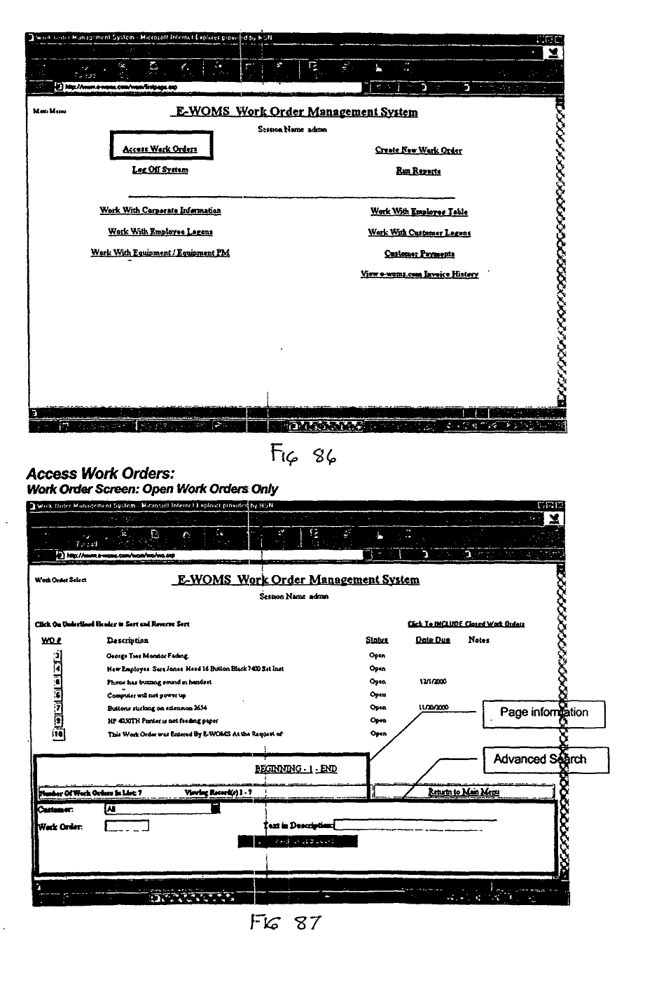

FIG. 86 is a vendor access work order screen,

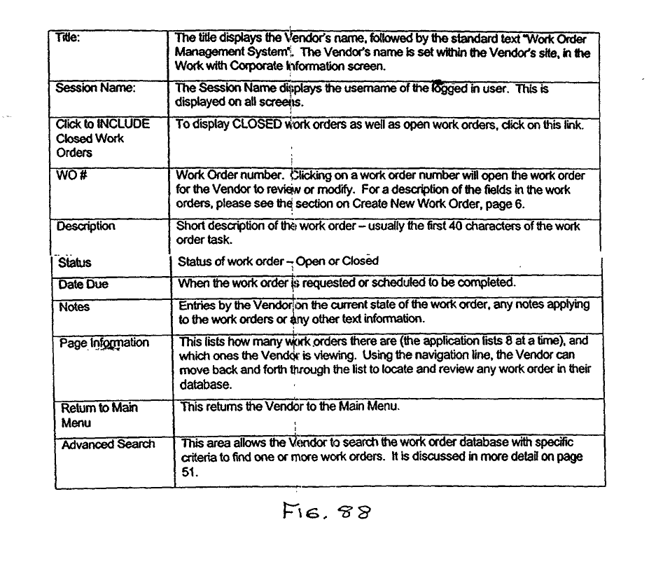

FIG. 87 is a work order screen for vendors,

FIG. 88 is a table accompanying FIG. 87,

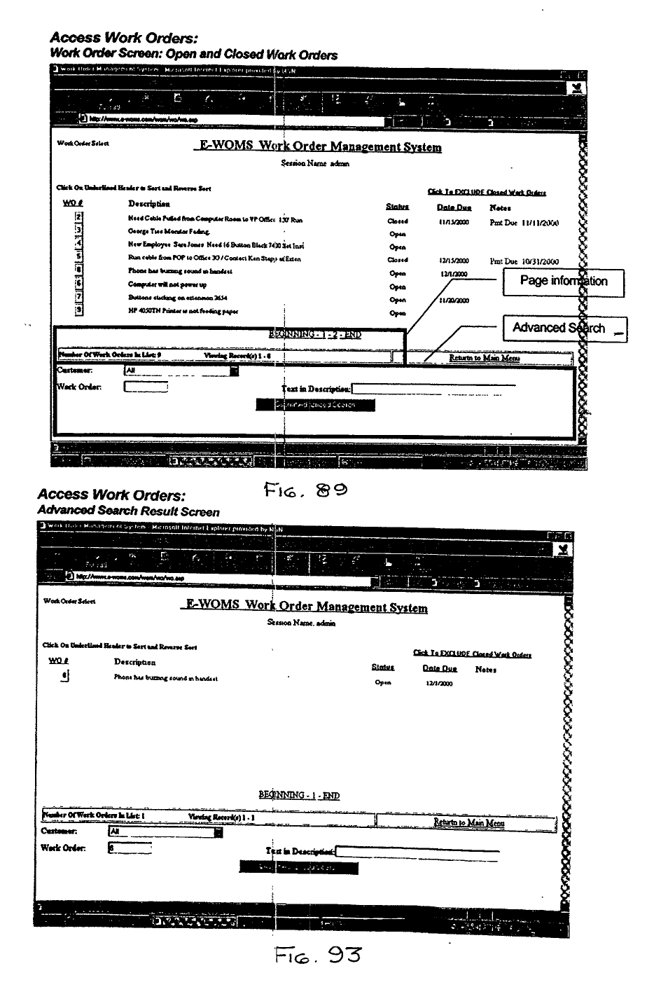

FIG. 89 is a vendor open and closed work order screen,

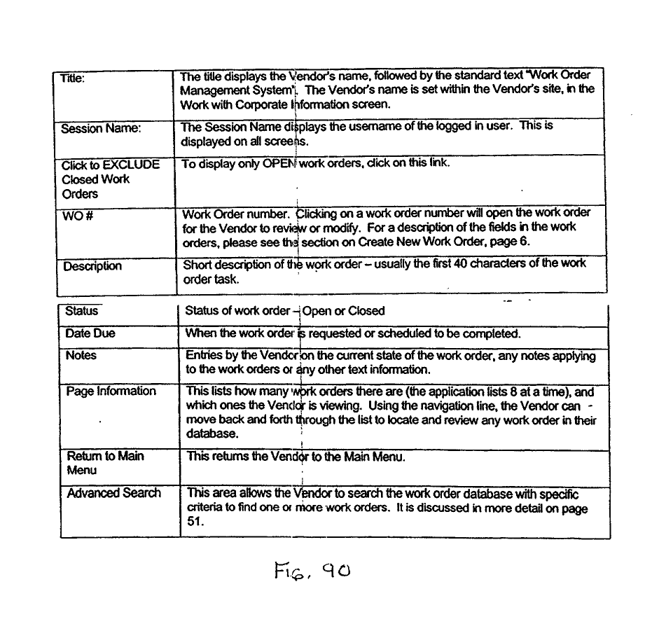

FIG. 90 is a table accompanying FIG. 89,

FIG. 91 is a vendor advanced screen,

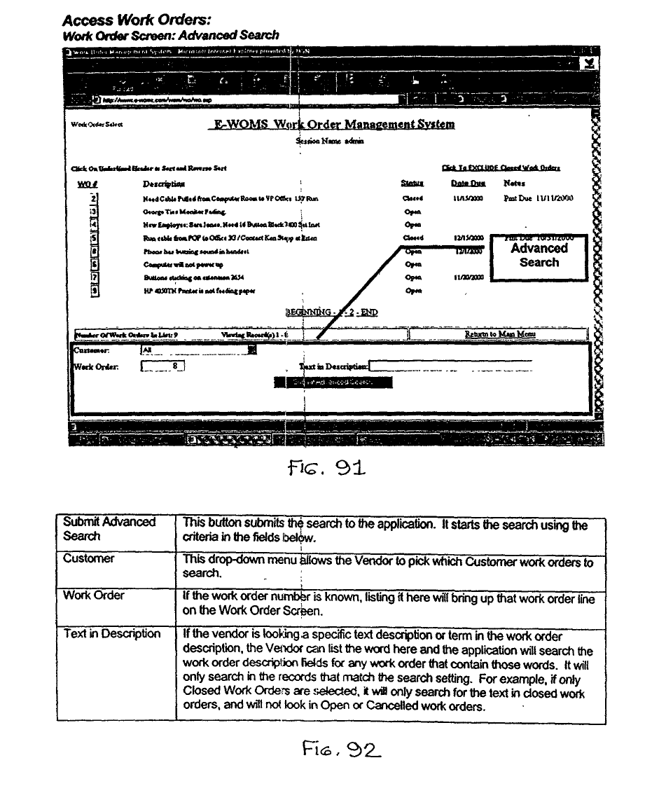

FIG. 92 is a table accompanying FIG. 91,

FIG. 93 is a vendor advanced search results screen,

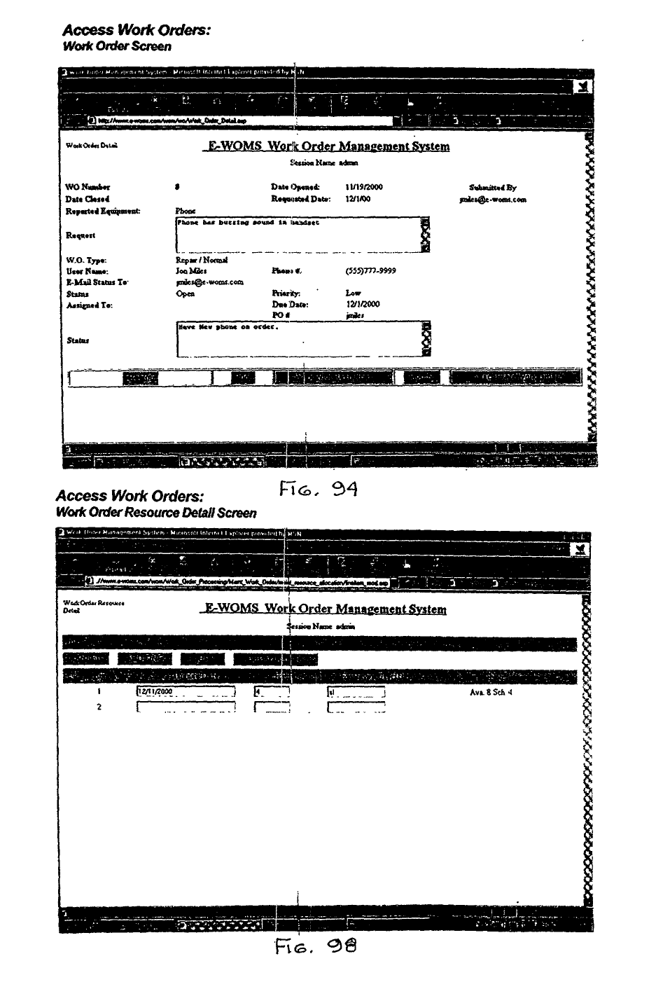

FIG. 94 is a vendor work order screen,

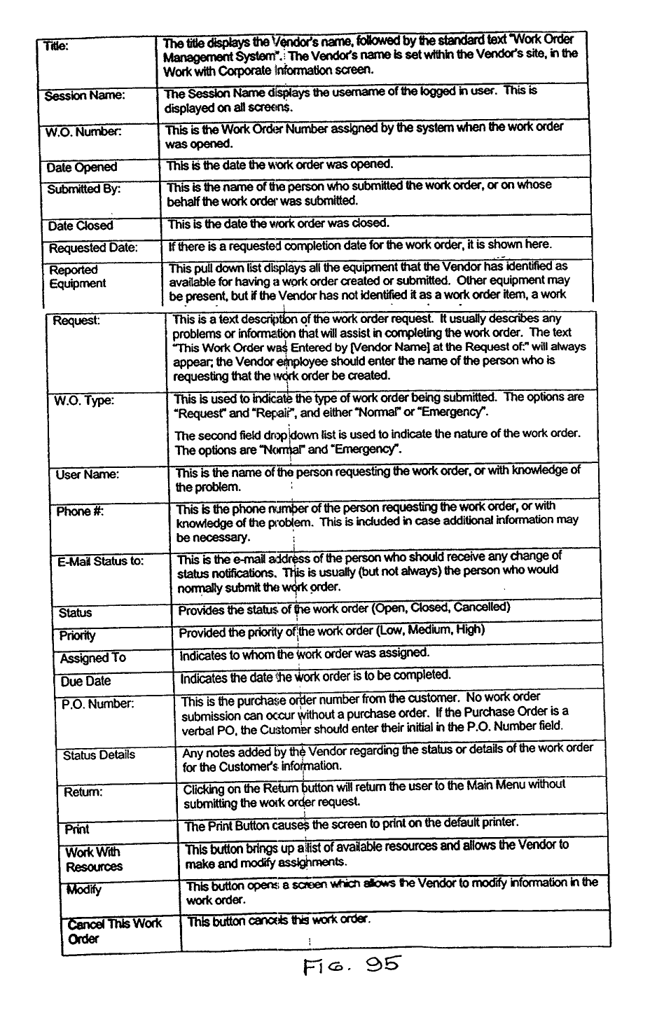

FIG. 95 is a table accompanying FIG. 94,

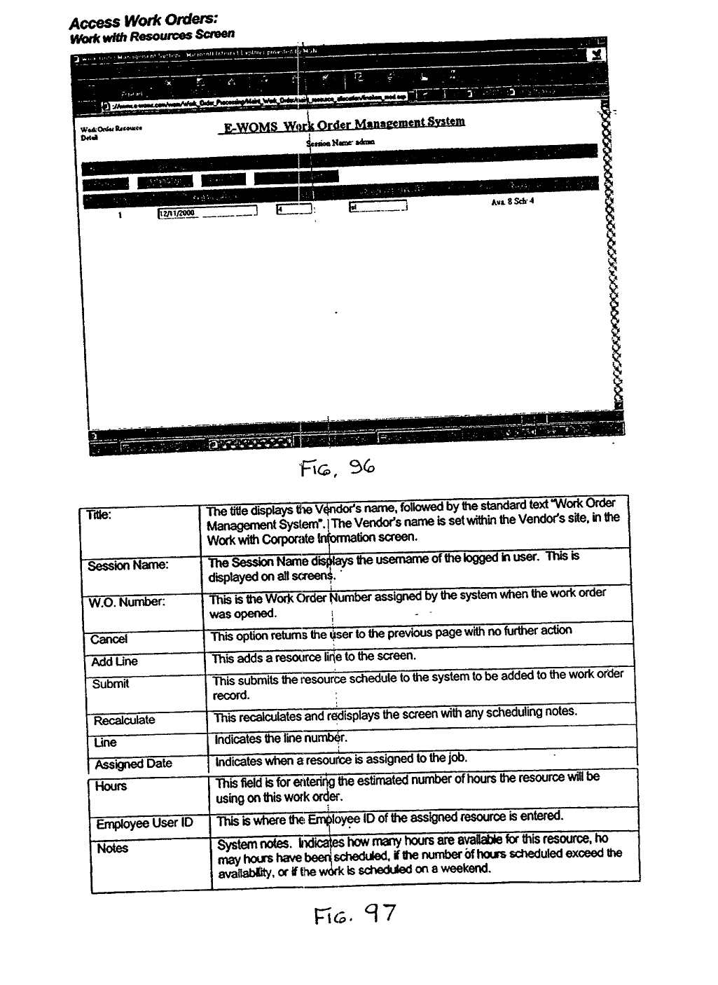

FIG. 96 is a vendor work with resources screen,

FIG. 97 is a table accompanying FIG. 96,

FIG. 98 is a vendor work order resource detail screen,

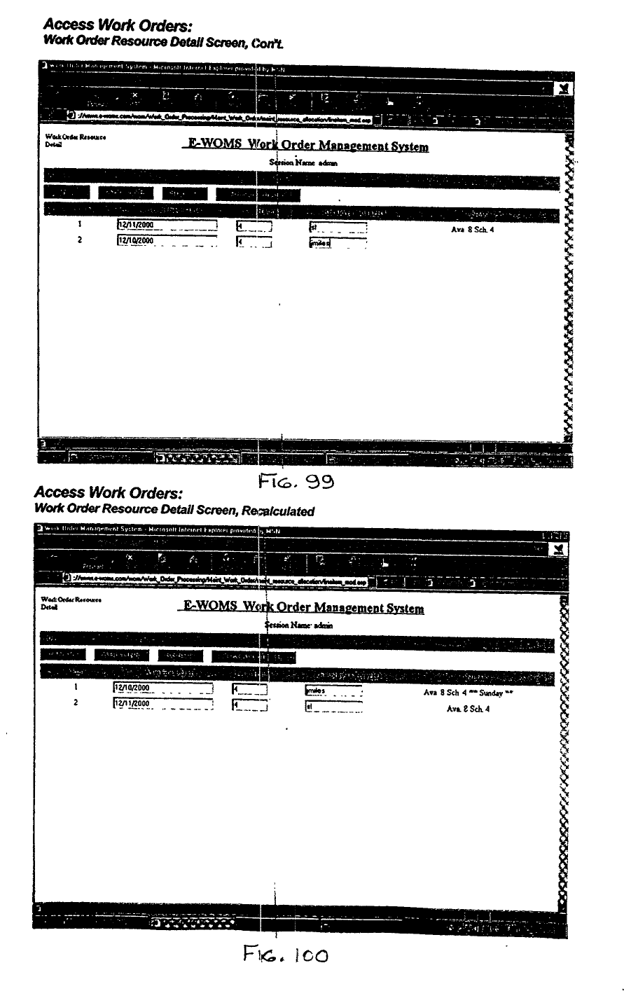

FIG. 99 is a vendor work order resource detail screen,

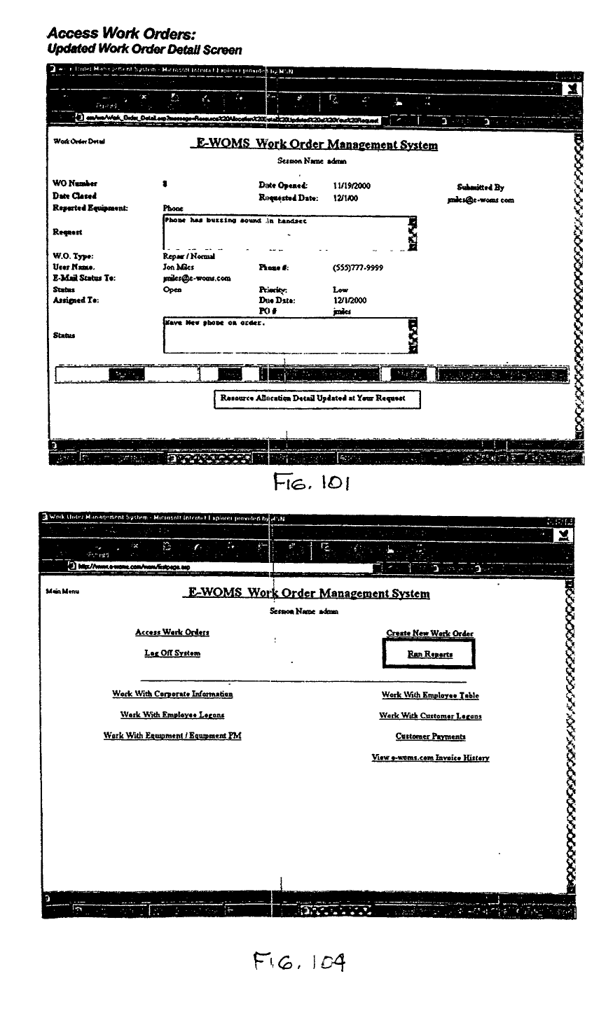

FIG. 100 is a vendor work order resource recalculated screen,

FIG. 101 is a vendor updated work order detail screen,

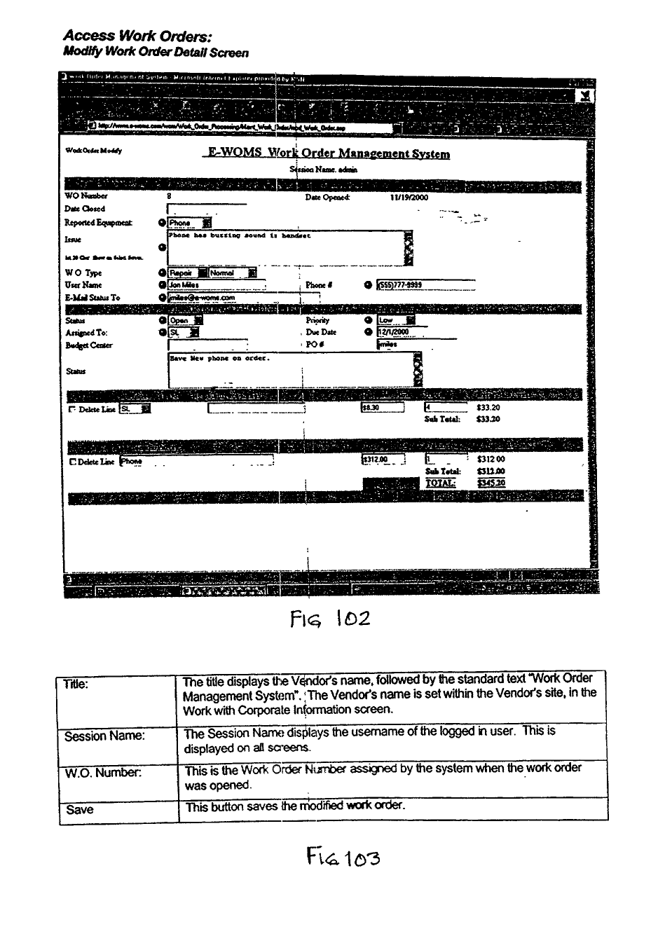

FIG. 102 is vendor work order modify detail screen,

FIG. 103 is a table accompanying FIG. 102,

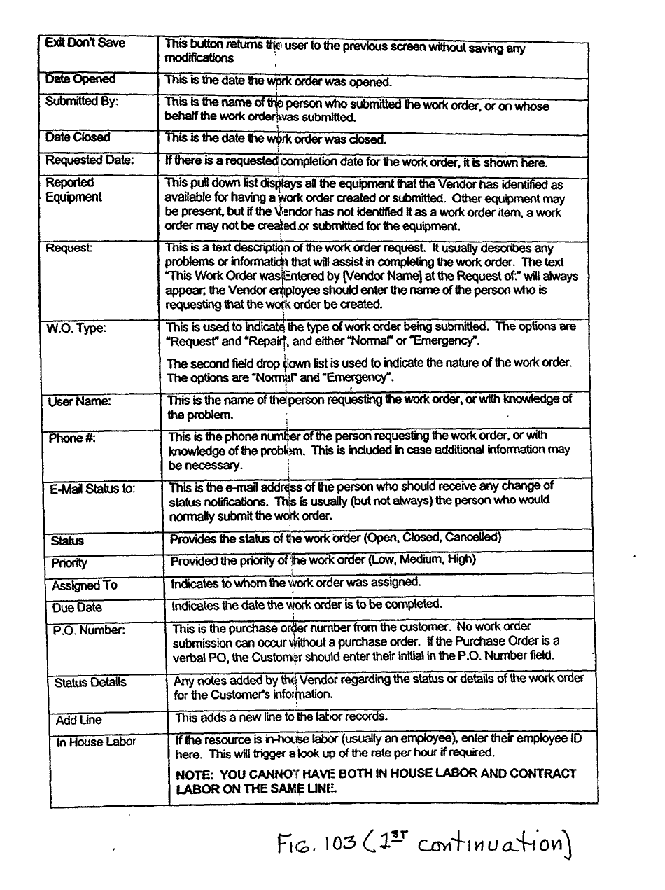

FIG. 104 is vendor reports screen,

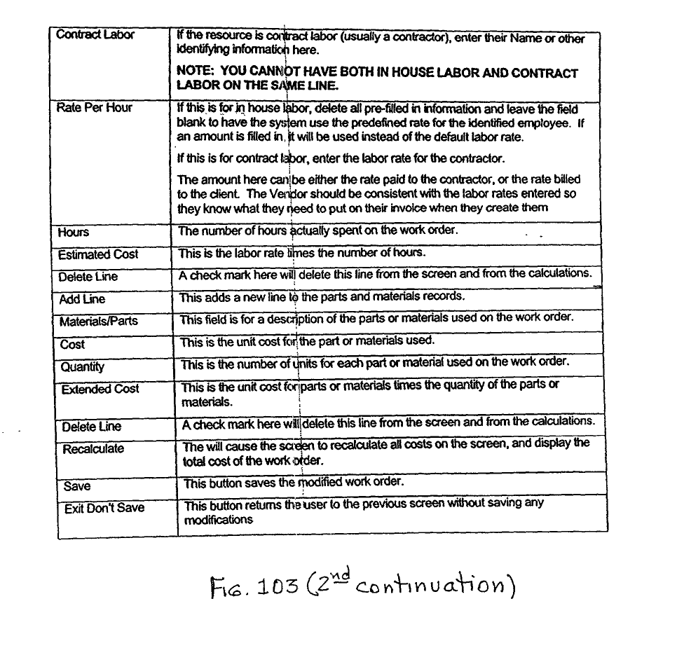

FIG. 105 is a vendor report menu screen,

FIG. 106 is a table accompanying FIG. 105,

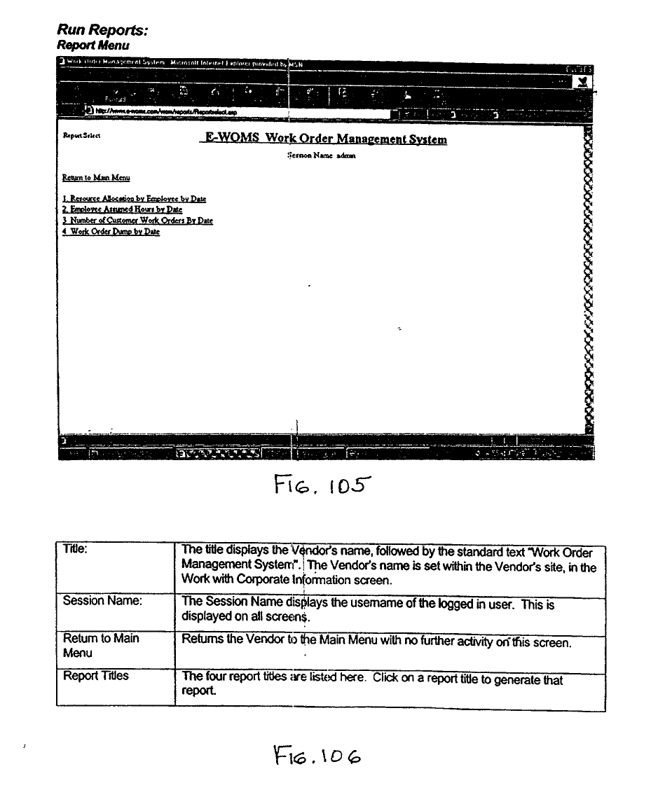

FIG. 107 is a vendor report period screen,

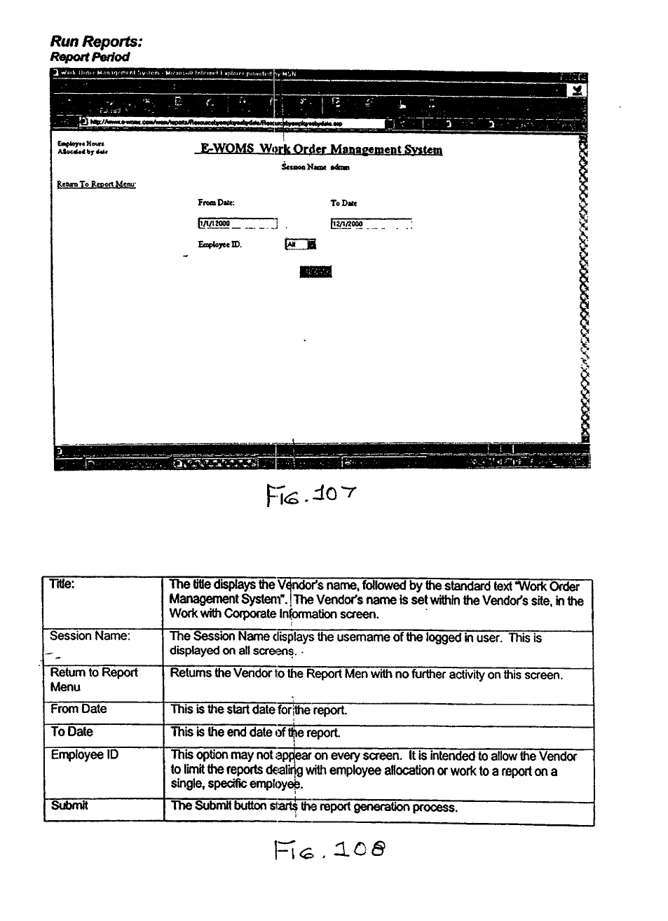

FIG. 108 is a table accompanying FIG. 107,

FIG. 109 is a vendor resource allocation by employee screen,

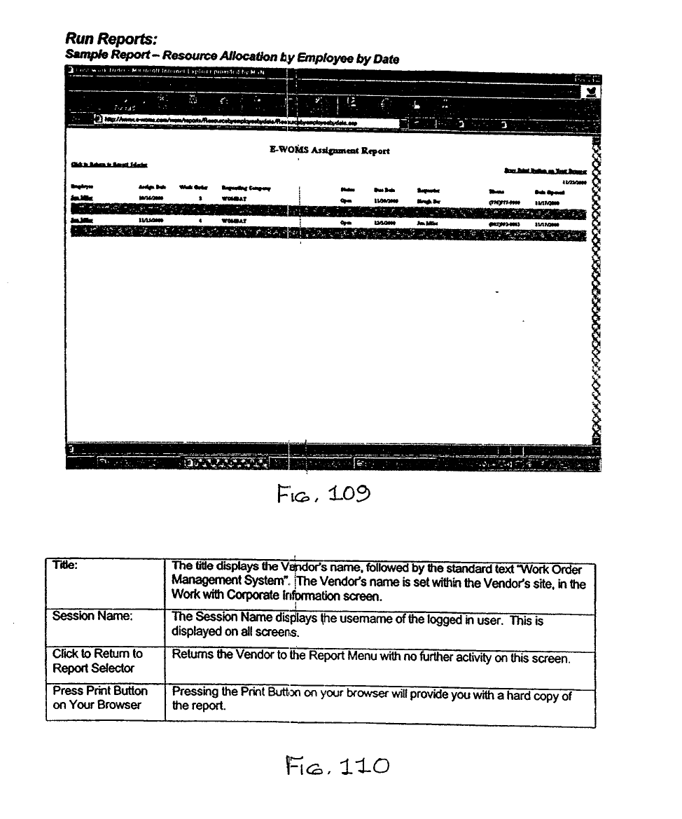

FIG. 110 is a table accompanying FIG. 109,

FIG. 111 is a vendor employee assigned hours screen,

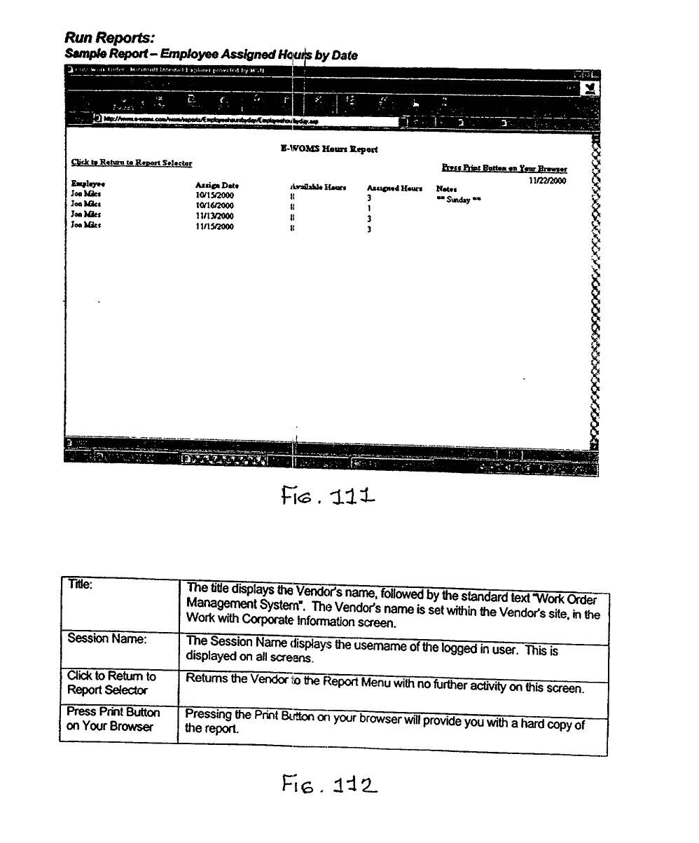

FIG. 112 is a table accompanying FIG. 111,

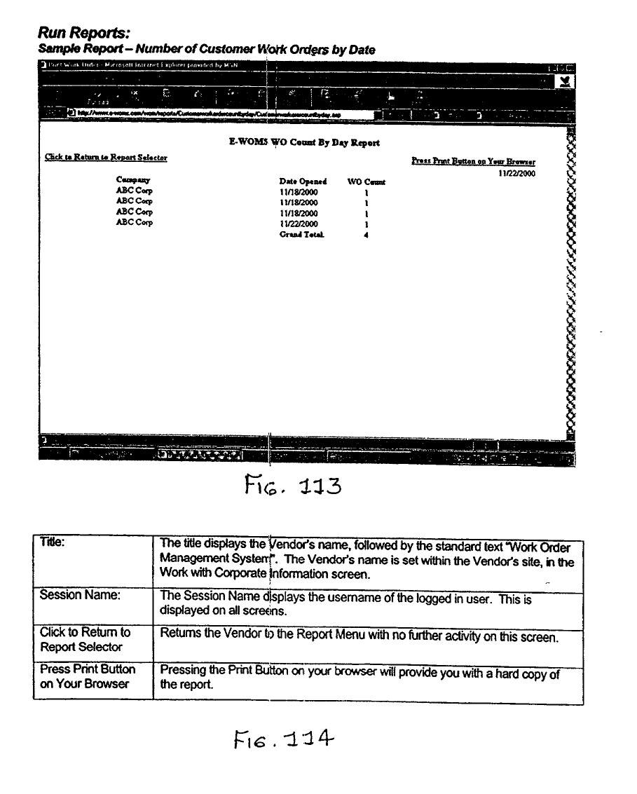

FIG. 113 is a vendor sample report screen,

FIG. 114 is a table accompanying FIG. 113,

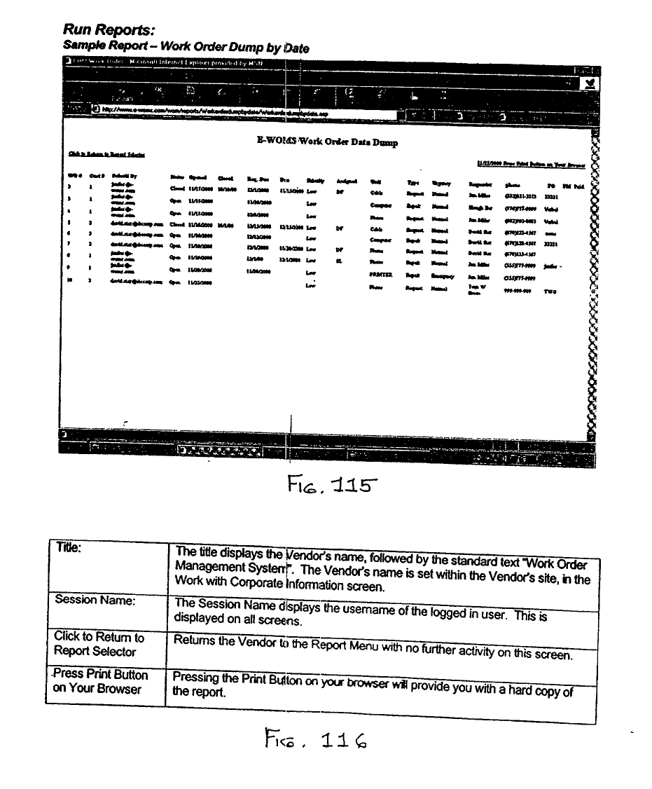

FIG. 115 is a vendor sample report screen,

FIG. 116 IS a table accompanying FIG. 115,

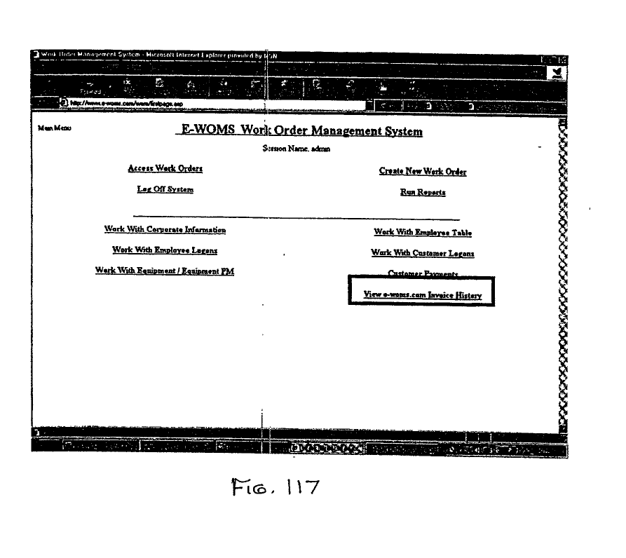

FIG. 117 is an invoice screen for the operator of the system,

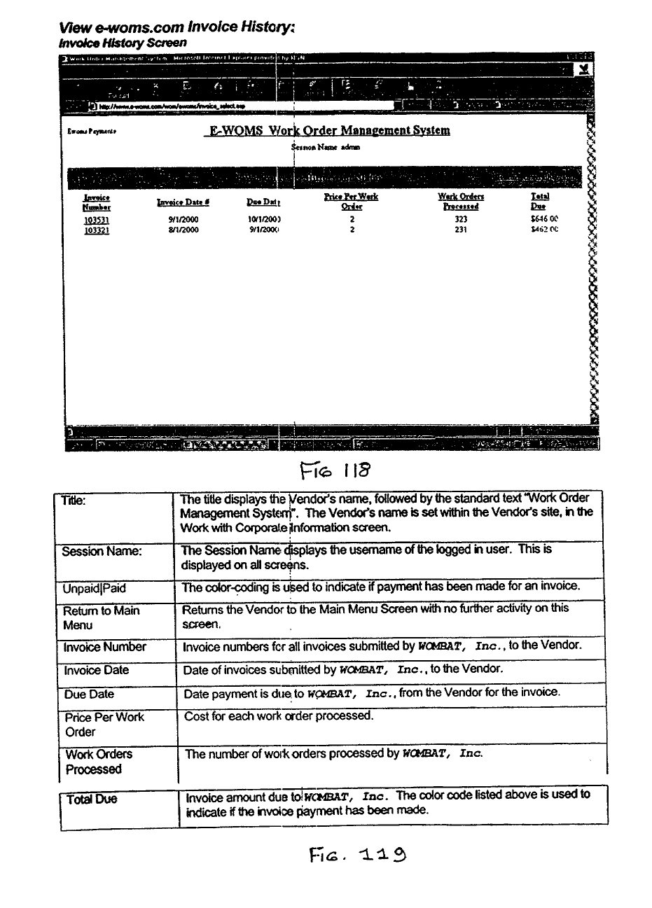

FIG. 118 is an operator invoice history screen,

FIG. 119 is a table accompanying FIG. 118,

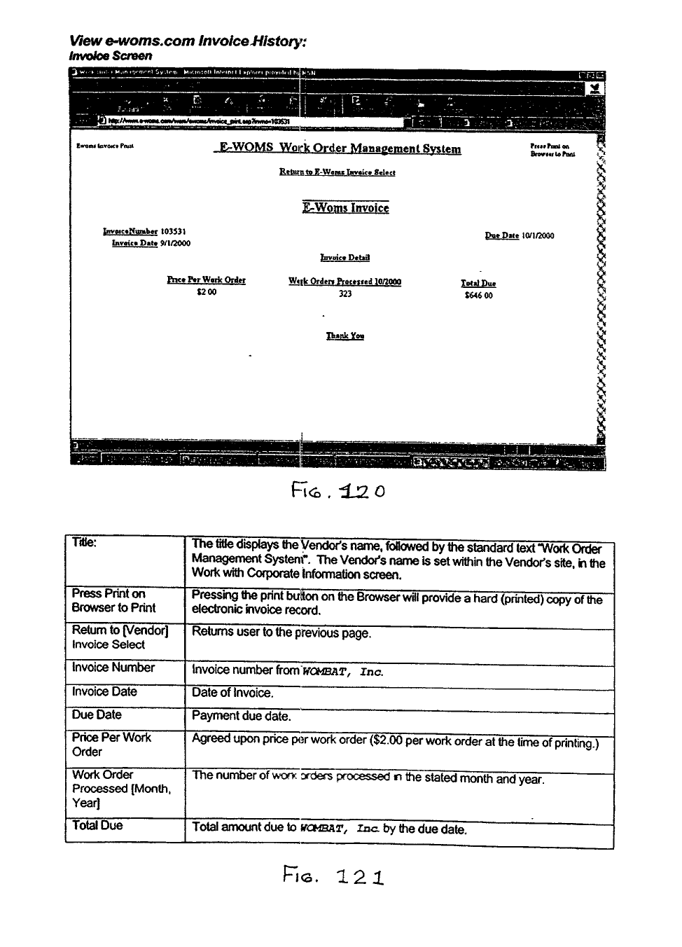

FIG. 120 is an operator invoice screen, and

FIG. 121 is a table accompanying FIG. 120

### DETAILED DESCRIPTION OF CUSTOMER SITE OF THE SYSTEM

Customer Login

Referring now to FIG. 1 there is shown the login screen. This screen is used for the vendor's customers. Each screen is customized to display the vendor's name, and each customer is provided a URL icon ( a URL address ) that automatically takes him or her to the login in screen for their vendor. A customer may submit work orders to several vendors who use the instant system. Each vendor, however, provides that customer with a separate URL icon for the vendor's own login page.

FIG. 2 shows the vendor's name, followed by the standard text “Work Order Management System”. The vendor's name is set within the vendor's site, in the Corporate Information screen. As noted, the username is the login name (the customer's e-mail address) assigned to the vendor's customer. A customer must have a valid username and password to log into the Work Order Management System. The customer enters his password as noted on the screen on FIG. 1. The Enter Button is clicked using the mouse to submit the entered username and password combination to the system for recognition and authentication for access. If the username and password authenticates, the customer will be logged into the vendor's Work Order Management System. If the user name and password do not coincide, or if the system does not recognize the user name, the user is returned to the Login screen and all fields cleared.

Customer Main Menu

FIG. 3 shows the Main Menu Screen that the customer sees once they have been authenticated and logged in. Key components of the screen are described in FIG. 4. Each of the four main menu items is described below and each of the selections is explained. The title displays the vendor's name, followed by the standard test “Work Order Management System”. The vendor's name is set within the vendor's site in the Corporate Information screen. The Session Name displays the user name of the user presently logged in which is displayed on all screens. The user then employs the Create New Work Order Selection link which takes him to the form for submitting a new work order. By employing Access Work Order Selection the user is linked to the list of previously submitted work orders (if any) which is used to check the status of already submitted work orders. In using Log Off Selection, the user links off the system which takes him back to the login screen. The Change Profile Information Selection link takes the user to a form that will allow them to change the information about themselves.

Change Profile Information

FIG. 5 shows the user profile screen which is used to look at a profile as well as to enter changes such as contact information, e-mail addresses and to reset the passwords.

FIG. 6 shows the Change Profile screen which allows users to change user information. The information, noted in FIG. 7, includes such information as e-mail address, First and last names, phone and fax numbers, new passwords and confirmation, etc. which the user enters by hitting the update button or canceling it with the cancel button.

FIG. 8 shows the Change Profile Information screen. The system provides on-screen feedback on user initiated actions. In such a case, the screen display shows that the user profile was updated, at the user's request. The System information indicates when action was taken or not taken at the user's request.

Create New Work Order

FIG. 9 shows the Create New Work Order Screen by which customers create and submit work orders from the Create New Work Order Selection.

FIG. 10 shows the Create New Work Order Screen which is brought by pushing Create New Work Order on the screen of FIG. 9. This is where the initial work order is created and submitted. Each field is discussed in FIG. 11. Once the form is completed clicking the submit button will submit the work order, clicking the Return button will return the user to the Main Menu without submitting the work order. As noted, The Reported Equipment pull down list displays all the equipment that the vendor has identified as available for having a work order created or submitted. Other equipment may be present, but if the vendor has not identified it as a work order item, a work order may not have to be created or submitted for the equipment. If a customer needs to other equipment added to the list he may contact the vendor. The Request is a text description of the work order request which usually describes any problems or information that will assist in completing the work order. The P.O. number is the purchase order number from the customer which is necessary to obtain a work order submission. The customer should put his initials in this box if it is a verbal purchase order. The Requested Completion Date is entered here if necessary. The W.O. type is a drop down list used to indicate the type of work order being submitted. The options are Request and Repair. The second field drop down is used to inicate the nature of the work order and the options are Normal and Emergency which are self-explanatory. The name of the person submitting the order is entered together with phone number, e-mail information, person to notify and submitted.

FIG. 12 shows the Create New Work Order Screen where screen action is not taken at the user request. The system notifies the user of actions taken or not taken using an on-screen message. The screen indicates that the work order was not submitted. If it had been submitted the system would have displayed the work order number.

Access Work Orders

FIG. 13 shows the Access Work Order Screen with the selection to view previously submitted work orders.

FIG. 14 shows the Access Work Order Screen showing open work orders only. This screen displays only the open work orders which is indicated by the Open/Closed Work Order View Selector above the upper right hand corner of the table. The user can use this screen to review the status of open work orders. From this screen the user can also select to view a submitted work order. While viewing the work order, the user has the option to cancel the work order. FIG. 15 identifies the components of the screen on FIG. 14. If the vendor has indicated that you are to see a past due indication on past due work orders, all past due invoices will appear on the listing regardless of whether or not the screen is set to show closed work orders.

The List Sort Information in FIG. 15 is an information line. The table of work orders may be sorted in any number of ways. Any underlined column can be used to sort the table. The Open/Closed Work Order View Selector will only include open work orders as shown or may be clicked to show both open and closed work orders. FIG. 16 shows closed work orders. The vendor may hide this option from the customer if the Allow Access to History is not checked in the customer account profile screen on the vendor side The work order, description of work, status, due date and notes are all noted. The WO Navigation indicates how many pages of work are available for display and the user may change the page to be viewed. The Information and Navigation Bar, left side, is used to indicate how many items are in the list of work orders and how many are currently viewed on-screen. The right side contains the link to the Main Menu.

FIG. 16 shows the Access Work Order Screen indicating Open and Closed Work Orders. The screen is similar to FIG. 14 except that this screen shows both open and closed work orders. A ”2” following the “1” would indicate that more work orders are available for viewing. If the vendor has indicated that the customer is to see a past due indication on past due work orders all past due invoices will appear on the listing regardless of whether or not the screen is set to show closed work orders.

FIGS. 17 and 18 show the Access Work Order Work Details Screen which is opened when the user selects a work order number This screen is a view-only screen and displays the information entered when the work order was first created plus any other information added after the initial submission. Most of the fields on this screen are the same as previously discussed or are self explanatory. The new information listed include Assigned To, which indicates the responsible party, the Status Detail, containing added notes, the Navigation Bar, which lists options and the Cancel.

This concludes the discussion of the customer or user screens.

DETAILED DISCUSSION OF VENDOR SITE OF THE SYSTEM

Again, the Work Order Management System is an application service provider program that allows clients (vendors) to have their own work order management system without having to have their own internal IT organizations. The application runs on the owner/installer servers and provides the vendors the power and flexibility of a fill power work order management system network by using the internet.

Login

FIGS. 19 and 20 show the login screen for the vendors and the table of notations, respectively, Each screen is customized to display the vendor's name and each vendor is provided with a URL icon (a URL address) that automatically takes him or her to the login screen for their Work Order Management System. Each vendor will provide their customers with a URL icon for the vendor's login page. FIG. 20 is a table outlining the major screen components. The Username and Password age, again, are peculiar to the vendor using the screen and it must be valid to enter the system.

Main Menu

FIGS. 21 and 22 show the Main Menu Screen and the selections thereon, respectively. This is the screen that the customer will see once they have been authenticated and logged in. Key components of the screen are described in FIG. 22. Each of the 11 main menu items is described there. It should be noted that which option on the screen in FIG. 21 you can operate is determined by your access privilges. Everyone can see Access Work Orders and Log Off System but all other options are controlled by settings in the “Work With Employee Logons” sections. In the title the vendor's name is set within the vendor's site, in the work with Corporate Information Screen. The name of the logged on user appears in the Session Name display and the Create New Work order allows the vendor to create a work order on behalf of a customer. The Work with Customer Logons link allows the vendor to create customer accounts and the Work with Equipment link allows the vendor to determine what equipment is available and what the customer can select from the drop down menus. An added bonus is that it allows the vendor to schedule preventive maintenance on a regular schedule. The Work with Employee Table allows the vendor to work with vendor employees who will be involved. The vendor can also access and modify vendor employee accounts by Work With Employee Logons and review customer payments by Customer Payments. The vendor can also modify information about itself and to run reports from a report menu. A view of the owner/installer invoices is also available on View E-woms.com Invoice History.

Work with Corporate Information

FIG. 23 shows the Work With Corporate Information Screen where the vendor information is posted. This is what the customer sees when they log on to submit a work order. FIG. 24 shows the Corporate Information Screen with the information listed and is where the customer and web site information is drawn from. The logged in user name is displayed in the Session Name and the Save saves the information to the System. The contact information such as name, phone, fax, employee key contact, and web home page is displayed. It may be that the customer can auto register on the screen at this time.

Work with Employee Table

FIG. 26 shows the Work With Employee Table which has the capability of entering the vendor employees into the system. These individuals are usually those who will be performing the work to complete the work order or supervisors or managers who are assigning or reviewing the work assignments. Employees are identified here and may be logged on.

FIG. 27 shows the Work With Employee Table for the system. Table 28 shows the employee screen information by which the vendor can add new members, return to Main Menu, check employee numbers and name and check other items. FIG. 29 shows the screen for adding a New Team Member by which the vendor authorizes its employees to have access to the system. Employee Access Privileges are not set here, on upon the account creation. Access Privileges are set in “Work With Employee Logons”. As shown in Table 30, the vendor can add new employees by a certain identification such a name or number as well as the hourly rate and hours per day available for the work.

FIG. 31 shows the Work With Employee Table with the Modify Employee Screen which allows the vendor to modify information about an existing employee. It allows for an employee ID which is unique to that employee and cannot be changed once it has been entered.

Work with Employee Logons

FIG. 33 shows the Work With Employee Logons where employees are given logon permission to use the Vendors area in the system by the vendor. Employee privilges and access rights are assigned based on the employees job and the vendor's policy about access to information. Permissions are granted by the vendor and the owner operator of the system has no responsibility in this regard.

FIG. 34 shows the Employee Screen for employees who have been given logon permission by the vendor. The screen can be sorted by clicking on the column headings. Additional clicks on the column heading will reverse the sort from ascending to descending, etc. The Table 35 shows the various selections which are self-explanatory.

FIG. 36 and Table 37 show the function of adding a New Employee Screen. This is where the vendor assigns new rights and permission to employees. Table 37 shows the different instructions which allow different levels of access to information to the employee such as Allow This User to Work With Customer Login Accounts or Allow this User to Access Customer Payments. These different access authorizations have to do with the functions the employees are carrying out in the vendor company, such as bookkeeping, scheduling equipment, interfacing with the customer to change work orders or to work with other employees on their work schedules. The employee may also create a work order for the customer who may be unable to create the work order himself from the customer web site for some reason. As stated, the Payment Due function is important and should be set up during the user setup as all work orders may show up as past due if added later. Done properly, this allows vendor to record payments against work orders to insure tracking.

FIG. 38 shows show the Modify Employee Screen for the Work with Employee Logons where the vendor modifies logon names and specific rights and permissions to employees. Table 39 shows the various options open to vendor in this regard where, after identifying the employee, can allow the user to view the e-Woms Invoice History (billing of system owner and operator), all the user to work with corporate information including modifying it allow the user to work with work order parts and labor and other possibilities. This is established during user set so that the records remain coherent.

Work with Customer Logon

FIG. 40 shows the screen for working with the Customer Logon which allows the vendor to create customers, modify customer information, add and modify customer users and examine logon records for customer users. FIG. 41 and Table 42 show the customer selection screen for this portion of the operation of the system. Selecting Work with Customer Logon brings up this screen. This is where the vendor creates and identifies customers, assigns the Company name that appears on the customer screen when the customer logs on and works with the customer user information. Table 42 shows the options available with this screen. Note that the Company name is assigned by the owner of the system, Wombat, Inc., in this case when the vendor creates a new customer. It is used to identify the customer company in the system database and is never seen by the customer. However, the customer company name is assigned by the vendor when it sets up the customer account. This is the name seen at the top of the customer screens when they log on. The Work with Accounts link allows the vendor to look at the Customer Account screens where they can review or modify account information for individual users authorized by the customer.

FIG. 43 show the Add New Company Screen where the vendor enters the customer information. The Company Number shows “NEW” as no number has been assigned as yet to the customer. Pressing submit assigns a number to the customer. Other identifying information such as names, addresses, contact person, and payment terms are all identified on this screen as shown in Table 44.

FIG. 45 shows the Modify Company Information Screen which, by clicking on the Company Number will open the Change Company information screen. Here the vendor can modify the Customer Company information for an existing Customer, or the vendor can delete the Customer from the database of vendor's customers. Table 46 shows the various information and options available with this screen. Submit enters the customer information to the system to be entered as a customer for the vendor. The Company Name and Payment Terms can also be entered and the Company Name appears on the Customer Work Order in the Application Title when they are entering a work order.

FIG. 47 shows the Work with Accounts Screen for the system which brings the user to a list of user accounts. As noted in Table 48 the link refreshes the Account Menu page so any changes show up. Also available are the Main Menu and the Work with Company Menu as well as the Submit Changes and Active Checkbox options. The Submit Changes submits the data on the screen to the database and the Active Checkbox selects whether the user account is active or inactive. This selection can also be used to render an account temporarily inactive. The user is assigned a number by Wombat or the operator of the system and clicking for user numbers brings up a history of logins for that user.

FIG. 49 shows the Login Statistics Screen which displays the most recent login for each of the customer users. Clicking on any header will sort the list according to the accompanying column. The sort will alternate between any ascending and descending sort. One clicks on “Return to Previous Page” to exit this screen. Table 50 shows the explanation of the options.

FIG. 51 shows the User Log Screen for Working with Customer Logon and clicking on a user number will display a login history for that user. One clicks on “Return to Previous Page” to exit. FIG. 52 shows the table of instructions.

FIG. 53 shows the Modify User Screen for the Work with Customer Logon. FIG. 54 shows the table of options for the screen. Note that the Delete button allows the vendor to delete a customer user account and Save allows saving of the modified customer account information. A check in Allow Access to History allows the user to access the historical work orders and a check in Can Cancel Work Orders allows user to cancel work orders. The Show Late Payments box shows the late payments by customer and a New Password option is also provided.

FIG. 55 shows the Create New User Screen for Work with Customer Logon and this is where the vendor creates a new customer user. FIG. 56 shows the table of options for this screen which are self-explanatory.

Work with Equipment/Equipment PM

FIG. 57 shows the Work With Equipment/Equipment PM (periodic maintenance) screen which allows the vendor to identify the equipment they work with, schedule periodic maintenance for that equipment and to limit what a customer can see in the pull down menu displayed on the work order screen. FIG. 58 shows the Equipment Screen for the Work with Equipment/Equipment PM which displays the equipment the vendor has entered into their equipment database list. The list can be sorted by Equipment Name, whether or not the equipment appears in the work order pull-down menu or description. Sorting this list is done by clicking on the name of the column. Repeated clicks reverse the sort. FIG. 59 shows the Table of options available on the screen including a description of the equipment, its name, whether or not the equipment shows up in the drop down menu and to schedule preventive maintenance on the equipment.

FIG. 60 show the Add New Equipment Screen for the Work with Equipment/Equipment PM where the vendor enters new information on any new equipment added to the database. FIG. 61 showing the table is self-explanatory.

FIG. 62 shows the Modify Equipment Screen for the Work with Equipment/Equipment PM where the vendor accesses this by clicking on the name in the first column of any equipment on the list. This is where the Vendor modifies the information on any equipment already entered into databases. FIG. 63 shows the table with the options such as Ref. No. which gives each piece of equipment a unique reference number. The equipment can appear in the customer drop down menu on the work order entry screen if the box is checked. The preventive maintenance person's e-mail address is also given.

FIG. 64 shows the Equipment PM Schedule Screen which is accessed by clicking the “Equipment PM” link next to an item on the Equipment Screen by the vendor. The vendor can see what Preventive Maintenance orders are scheduled for the equipment as well as the scheduled period and when the item was last submitted for scheduled preventive maintenance work. FIG. 65 shows the table of options most of which are self-explanatory. The Add New Pm allows the vendor to enter a new schedule Preventive Maintenance order to the item of equipment.

FIG. 66 shows the Add New Equipment Screen for the Work With Equipment/Equipment PM where the vendor enters information on any new equipment added to the database. FIG. 67 shows the Table with the screen options such as Save which enters the data to the operator for entry into the vendor equipment list as well as information concerning the equipment itself. The Cycle Time and Cycle Type concern the frequency of work orders and allows the usage planning of the equipment.

FIG. 68 shows the Modify Equipment PM Schedule Screen for the Work With Equipment/Equipment PM where the vendor modifies the scheduled PM request orders. FIG. 69 shows the table listing the options available which include showings of preventive maintenance cycles.

Customer Payments

FIG. 70 shows the Customer Payments Screen where the vendor can review the work order and payment status of the work orders submitted by the customer. FIG. 71 shows an example of a Customer Payment Screen of Customer Payments where the information can be sorted by clicking on the column headers. Additional clicks on a header reverses the sort from ascending or descending. The screen shown has been sorted by Status, all closed work orders are at the top of the page. FIG. 72 shows the table of options available including WO# which allows the vendor to review or modify the work order, Closed Date showing when the work order was completed, Page Information listing how many work orders there are and which ones are being viewed. Using the navigation line the vendor can move back and forth through the list to review any selected work order in the database. The options also include Show Only Past Due and Text in Description, the latter of which allows the vendor to access any work order with a particular word.

FIG. 73 shows the Work Order Details Screen of Customer Payments which is the work order selected on the screen in FIG. 71. FIG. 74 is a table listing the options including Reported Equipment, which is a pull down list that displays all the equipment that the vendor has identified as available for having a work order created or submitted. Also included on the screen is Request, a text description of the work order request, W.O. Type, which identifies the type of request, Status showing the status of the work order, information about the person requesting the work order and date of it, P.O. Number which is the purchase order number from the customer and Edit Comments where the user can record vendor-only comments on the work order. FIG. 75 shows this screen as Edit Comments Screen of Customer Payments. FIG. 76 shows the table of options available on the screen

FIG. 77 shows the Payment Detail Screen for Customer Payments which is the work order shown in FIG. 73. FIG. 78 is a table listing the options such as Paid in Full, Payment Date and Check Number.

Create New Work Order

FIG. 79 shows Create New Work Order whereby the vendor can create a new work order on behalf of a customer. This may be necessary if the authorized customer users are not available and a work order must be submitted immediately. Ideally, the customer would call the vendor and request the vendor enter the work order in the authorized user's absence. If this function is used with frequency then the customer should authorize more of its own users.

FIG. 80 is the Customer Selection Screen for Create New Work Order which one starts by selecting which customer the work order is being created for. The drop-down menu lists all the customers the vendor has created and allows the vendor to select the customer who is requesting that the work order be created. FIG. 81 shows the table of options available to the user which are self-explanatory.

FIG. 82 shows the Blank Form Screen for Create New Work Order which displays once the customer has been identified. Each field of the form is discussed in the table of FIG. 83. Once the form is completed clicking the submit button will submit the work order; clicking the Return button will return the user to the Main Menu without submitting the work order.

FIG. 84 shows the Completed Form Screen for Create New Work Order. It is a sample of a complete New Work Order screen and the explanation of the fields appear in the table of FIG. 83.

System Information on Main Menu

FIG. 85 shows Action taken at user request Screen on System Information on Main Menu. Whenever the user requests an action the system will display an informational message on the screen. In the case shown, the message indicates that the work order was submitted and provides the work order number.

Access Work Orders

FIG. 86 shows the Access Work Order selection which allows the vendor to review all work orders submitted by the vendors customers. This is a valuable tool in planning the effort for the forthcoming period for any vendor. FIG. 87 shows Work Order Screen:Open Work Orders Only which is what the vendor sees when they click the Access Work Order selection on the Main Menu. The screen shows only the open work orders. The vendor can then elect to show closed work orders by clicking on the link to INCLUDE closed work orders. The information will be sorted by clicking on the column headers. Additional clicks on the column headers will reverse the sort to ascending or descending. FIG. 88 shows the table of options available including Click to INCLUDE Closed Work Orders, just mentioned, and Description and Page Information.

FIG. 89 shows Work Order Screen: Open and Closed Work Orders which the vendor sees by clicking the INCLUDE function. The screen shows only open and closed work orders and the vendor can elect to remove closed work orders by clicking on the link to EXCLUDE closed work orders. The information can be sorted by clicking on the column headers. Additional clicks on the column headers will reverse the sort. FIG. 90 shows the table of options available which is self-explanatory

FIG. 91 shows the Work Order Screen: Advanced Search function which allows the vendor to search the work order database for work orders that meet certain criteria. It will locate one or more work orders and display them in the same manner as shown in the previous screens. Search criteria can be combined, for example, a search can be done for only customer A looking for work orders with the words “Water Cooler” in the work order description. FIG. 92 shows the table of functions available.

FIG. 93 shows the Advanced Search Result Screen which is what a search described above would look like. Notice that only work order 8 is listed on the page. Clicking on the WO Number will open that work order for editing.

FIG. 94 shows the Work Order Screen for Access Work Order which displays the work order selected in FIG. 93. FIG. 95 shows the table of options available including Reported Equipment, a pull down list, Request, containing information that will assist in completing the work order, various contact information and Work With Resources which lists resources available to help vendor make and modify assignments.

FIG. 96 shows the Work With Resources Screen which allows the user to work with resource scheduling features of the system. This resource scheduling is optional but is provided to assist vendors in assigning and managing resources. FIG. 97 shows the table of functions available which includes Recalculate which recalculates and redisplays the screen with any scheduling notes, Assigned Date indicating date resource was assigned to the job, and Hours, for entering the estimated number of hours the resource will be used on the work order.

FIG. 98 shows the Work Order Resource Detail Screen which is what the previously described screen ( FIG. 96 ) would have looked like with the first line filled in and another line added. FIG. 99 shows the second line added on the screen. FIG. 100 shows the second line added and the screen of FIG. 96 recalculated.

FIG. 101 shows the Updated Work Order Detail Screen showing the updated of the Resource Allocation Detail. FIG. 102 shows the Modify Work Order Detail Screen which is a work order about to be mod fled. Not everyone can see this screen or they may not be able to see all the elements of the screen. What can be seen is determined by the permission granted in the “Work With Employee Logon” screen. FIG. 103 shows a table listing the functions available which include the name of the person who submitted the work order, the requested date of completion, added information to assist in completing the work order, the name of the person requesting the order, the purchase order, the status details, both contract and in-house labor allocated to order and the accompanying rates per hour, the estimated number of hours, the cost of materials, quantity of materials and the ability to recalculate all costs associated with the order on screen.

Reports

FIG. 104 shows the Run Reports which are four (4) reports available from this system. If there is a specific need for a custom report the operator can make it available upon request.

FIG. 105 shows the Report Menu for Run Reports and FIG. 106 shows the table of functions available which are self explanatory.

FIG. 107 shows the Report Period where the vendor will identify a report period by selecting a starting date and ascending date for the report. The system will limit the data output during this period. FIG. 108 shows the table with the functions available

FIGS. 109 through 116 show sample reports which can be generated by this system. FIG. 109 shows the Resource Allocation by Employee by Date screen which shows which work orders an employee has been assigned, when the work order was assigned, the state and the other information about the work order. FIG. 110 shows the table of functions accompanying the screen. FIG. 111 shows a report for Employee Assigned Hours by Date screen which indicates how many hours of work each employee is assigned each day as well as how many hours each employee has available. This report also indicates if an employee is over-allocated or scheduled for weekend work. FIG. 112 shows a table of functions for this screen. FIG. 113 shows a report for Number of Customer Work Orders by Date indicating how many work orders were received, the company from which they were received and the date on which they were received FIG. 114 shows a table of functions for the screen of FIG. 113. FIG. 115 shows the Work Order Dump by Date report which is a dump of the data available on each work order. FIG. 116 shows the table of functions on the screen.

Invoices

FIG. 117 shows an e-woms invoice history with a listing of invoices from the system operator to the vendor. FIG. 118 shows a Invoice History Screen listing the invoices and FIG. 118 shows a table of functions for the screen including the number of invoices processed by the system operator, payment indication for each invoice, and amount paid. FIG. 120 shows the Invoice Screen and FIG. 121 shows a table of functions associated with the screen.

Having described the preferred embodiment of the invention, it will be obvious to those of ordinary skill in the art to make many changes and modifications without departing from the scope of the appended claims in which.

1. An on-line work order management system for accommodating a plurality of medium and small companies known as vendors and customers which is accessible from any web browser, said system comprising
a central database controlled by the system operator,
means by which customers can access the database by logging on with a proper ID,
means permitting said customers to create work orders for said vendors on said system and
means allowing said vendors to access said work orders and schedule work based thereon as well as notifying said customers of any changes in said work orders such as estimated completion dates and or equipment or material changes:

2. An on-line work order management system as in claim 1 and in which said means for allowing customers to create work orders to said vendors further allows said customers to review all previously submitted work orders to any given vendor and to update customer information for the benefit of the vendor

3. An on-line work order management system as in claim 1 and in which said system allows said customers to indicate the nature of the work order, whether normal or emergency or some other category and to make changes to said work order over time.

4. An on-line work order management system as in claim 1 and in which the vendor can run reports on certain aspects of the work order.

5. An on-line work order management system as in claim 4 wherein said report is a resource allocation by employee by date report.

6. An on-line work order management system as in claim 4 wherein said report is an employee assigned by hours by date report.

7. An on-line work order management system as in claim 4 wherein said report is the number of customer work orders by date report.

8. An on-line work order management system as in claim 4 wherein said report is a work order dump report

9. An on-line work order management system as in claim 1 wherein said means allowing the vendors to access the database to schedule work thereon allows them to create work orders.

10. An on-line work order management system as in claim 9 wherein said vendors are able to access both open orders and closed orders.

11. An on-line work order management system as in claim 9 wherein said vendors are are allowed to schedule equipment in conjunction with each work order.

12. An on-line work order management system as in claim 9 wherein said vendors are able to schedule the priority of the customer work orders and to establish completion dates.

13. An on-line work order management system as in claim 9 wherein said vendors are able to conduct a text search of all customer orders using a key word.

14. An on-line work order management system as in claim 9 wherein said vendors are able to allocate either or both in-house or contract labor to a work order.

15. An on-line work order management system as in claim 9 wherein said vendors are able to assign certain of its employees to access selected portions of the customer records regarding work orders and customer profiles.

16. An on-line work order management system as in claim 9 wherein said vendors are provided with a record of customer payments on work orders, can edit the records, and review both payment and work order details.

17. An on-line work order management system as in claim 9 wherein said vendors are able to review equipment available for each work order and schedule said equipment for said work order.

18. An on-line work order management system as in claim 17 wherein said vendors are able to schedule preventive maintenance on said equipment.

19. An on-line work order management system as in claim 18 wherein said vendors are able to modify said preventive maintenance schedule on said equipment.

20. An on-line work order management system as in claim 17 wherein said vendors are able to both add equipment to said work orders and to modify the equipment assigned to the work orders.

21. An on-line private work order management system for provision of application service program, said system allowing users, both vendors and customers, to have a work order management system without their own IT organization, said system comprising
a web based database controlled by the system owner,
vendor access means by which vendors can create work orders for their customers who may order from more than one vendor on the system
customer access means by which customers can submit their own work orders,
whereby said system allows for both vendor and customer access and review by either as to the status of said work orders.

22. An on-line private work order system as in claim 1 wherein customer access means allows for said customers to update information about itself on said database.

23. An on-line private work order system as in claim 1 wherein said customer access means allows customers to create their own work orders and while doing so to review equipment of the vendor available for use with their work order.

24. An on-line private work order system as in claim 1 wherein said customer access means allows the customer to be notified of action taken by the vendor in regard to it's work order.

25. An on-line private work order system as in claim 1 wherein said customer access means allows the customer to indicate whether the work order created is a normal or emergency work order.

26. An on-line private work order system as in claim 1 wherein said customer access means allows the customer's employees to review all previous work orders with a a particular vendor on the system.

27. An on-line private work order system as in claim 1 wherein said customer access means allows the customer to place work orders with any number of vendors on the system.

28. An on-line private work order system as in claim 1 wherein said customers are notified automatically by an e-mail whenever there has been a change in status of their work order or orders on the system.

29. An on-line private work order system as in claim 1 wherein said vendor access means allows vendors to set up customer accounts and modify them.

30. An online private work order system as in claim 1 wherein said vendor access means allows said vendors to assign its employees selective access to selected portions of said system for working with those areas within their job description.

31. An on-line private work order system as in claim 1 wherein said vendor access allows the vendors to display a record of customer payments on any one or several work orders that customer has with the vendor.

32. An on-line private work order system as in claim 1 which allows the vendor to create customer work orders on behalf of the customer and to review said work orders over time.

33. An on-line private work order system as in claim 1 which allows the vendor to run reports on one or more customer work orders or on resource allocations, employees assigned to the work order by hours and dates, or work orders by date.

34. An on-line private work order system as in claim 1 which allows the vendor to review the equipment used on work orders, to schedule said equipment according to work order and to schedule the maintenance of said equipment on a regular basis.

35. An on-line private work order system as in claim 1 which allows the vendor to review all customer payments, to add comments, to review payment detail and work order details.

36. An on-line private work order system as in claim 1 which allows the vendors to create vendor employee accounts each with a separate ID or password.

37. An on-line private work order system as in claim 1 which allows the vendor to modify information concerning itself on the database so as to change what is viewable by its customers.

38. An on-line private work order system as in claim 1 which allows the vendor to run an invoice history from the system operator.

39. An on-line private work order system as in claim 1 which allows the vendor to to access and review late payment information by its customers.

40. An on-line private work order system as in claim 39 which allows the customer to update its customer profile on said system.
